(19) United States
(12) Patent Application Publication
(10) Pub. No.: US 2013/0278140 A1
(43) Pub. Date: Oct. 24, 2013

(54) ELECTRODELESS PLASMA LAMP UTILIZING ACOUSTIC MODULATION

(71) Applicant: LUXIM CORPORATION, Sunnyvale, CA (US)

(72) Inventors: Sandeep Mudunuri, Sunnyvale, CA (US); Marc DeVincentis, Palo Alto, CA (US); Abdeslam Hafidi, Cupertino, CA (US); Walter P. Lapatovich, Boxford, MA (US)

(73) Assignee: Luxim Corporation, Sunnyvale, CA (US)

(21) Appl. No.: 13/866,496

(22) Filed: Apr. 19, 2013

Related U.S. Application Data
(60) Provisional application No. 61/635,526, filed on Apr. 19, 2012.

(51) Int. Cl. H05H 1/46

(52) U.S. Cl. CPC H05H 1/46
USPC 315/111.21

(57) ABSTRACT

An electrodeless plasma lamp is described that employs acoustic resonance. The plasma lamp includes a metal enclosure having a conductive boundary forming a resonant structure, and a radio frequency (RF) feed to couple RF power from an RF power source into the resonant cavity. A bulb is received at least partially within an opening in the metal enclosure. The bulb contains a fill that forms a light emitting plasma when the power is coupled to the fill. The RF power source includes a controller to modulate the RF power to induce acoustic resonance in the plasma.

### I. RELATED APPLICATION

This application claims the benefit of priority of U.S. Provisional Patent Application Ser. No. 61/635,526, filed on Apr. 19, 2012, which is hereby incorporated by reference herein in its entirety.

### II. FIELD

The field relates to systems and methods for generating light, and more particularly to radio frequency powered electrodeless discharge lamps.

### III. BACKGROUND

Electrodeless plasma lamps can offer very long operating lifetimes, typically into the tens of thousands of hours. The potential for long life is due to the lack of electrodes inside the bulbs, and the associated failure mechanisms associated with electrodes.

### III. BRIEF DESCRIPTION OF THE DRAWINGS

Some embodiments are illustrated by way of example and not limitation in the figures of the accompanying drawings.

FIG. 1 shows an electrodeless plasma lamp, according to an example embodiment, operating under normal excitation in which steady state RF power is applied;

FIG. 2 shows an example of un-modulated steady state power that may be applied to a resonator;

FIG. 3 shows operation of an example plasma lamp wherein the applied power is pulse width modulated (PWM), in accordance with an example embodiment;

FIG. 4 shows an example of pulse width modulated power applied to achieve excitation of acoustic resonance, in accordance with an example embodiment;

FIG. 5 shows example simulations of acoustic spectra for longitudinal and radial acoustic resonance modes in a bulb showing potential overlap of longitudinal resonance modes near desired modulation frequency ranges (fundamental radial mode);

FIG. 6A shows an example circuit to generate swept frequency PWM waveforms, in accordance with an example embodiment;

FIG. 6B shows a circuit, in accordance with an example embodiment, to combine swept PWM waveforms with an RF power circuit;

FIGS. 7A-7C show example waveforms to modulate RF power coupled to a lamp body of a electrodeless plasma lamp;

FIGS. 8A and 8B show a method, in accordance with an example embodiment, for performing pulse width modulation in a plasma lamp;

FIG. 9 is a block diagram illustrating components of a machine, according to some example embodiments, able to read instructions from a machine-readable medium and perform any one or more of the methodologies discussed herein;

FIG. 10A shows a schematic cross-sectional view of a plasma lamp and lamp drive circuit according to an example embodiment;

FIG. 10B shows a perspective cross-sectional view of a lamp body, according to an example embodiment, with a cylindrical outer surface;

FIG. 10C shows a perspective cross-sectional view of a lamp body, according to an alternative example embodiment, with a generally rectangular outer surface;

FIG. 11A shows a cross-sectional view of a plasma lamp, according to an example embodiment, in which a bulb of the lamp is orientated horizontally;

FIG. 11B shows a perspective exploded view of a composite lamp body, according to an example embodiment, with a bulb positioned horizontally relative to an outer upper surface of the lamp body;

FIG. 11C shows an example of a drive circuit coupled to the lamp shown in FIG. 11A when a feedback probe is provided;

FIG. 11D shows a further example of a lamp drive circuit coupled to the lamp shown in FIG. 11A when no feedback probe is provided;

FIG. 12A shows electrodeless plasma lamp, according to an example embodiment, including lumped components;

FIG. 12B shows a cross-sectional view of the lamp of FIG. 12A;

FIG. 13A shows a plasma arc shaping arrangement, according to an example embodiment, to modify a position and shape of a plasma arc;

FIG. 13B shows plan view of an example plasma arc formed by the plasma arc shaping arrangement of FIG. 13A; and

FIG. 13C shows a cross-sectional view of the plasma arc of FIG. 13B taken at A-A.

### IV. DETAILED DESCRIPTION

Example methods and systems are directed to electrodeless plasma lamps using acoustic modulation of plasma formed in a bulb. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

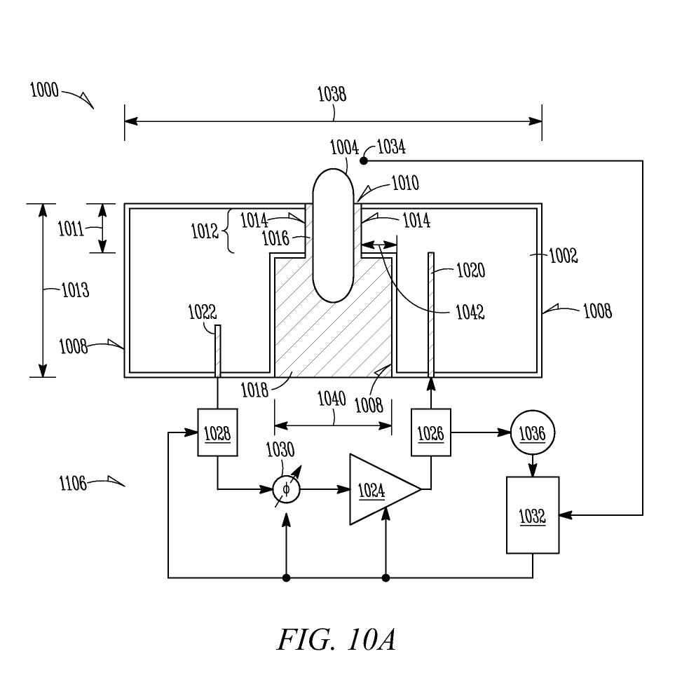

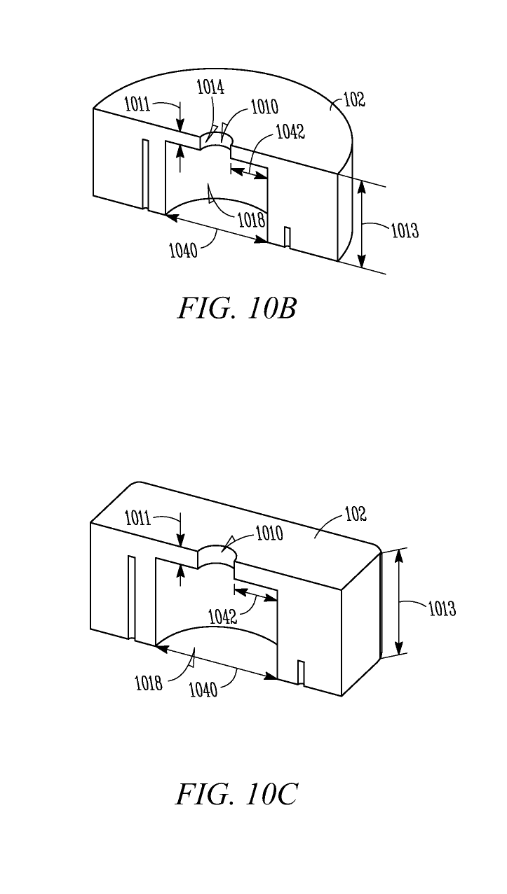

Example embodiments relate to high intensity electric discharge light sources. In one example embodiment, a class of high intensity electric discharge light sources referred to as electrodeless lamps or plasma lamps is described, wherein the name implies there are no internal electrodes in the bulb or plasma chamber; and, the energized medium is a gaseous mixture excited into a plasma state by the application of high frequency power. The plasma, or ionized gas thus sustained emits useful light. The high frequency power can be in the radio-frequency (RF), high-frequency (HF), very-high frequency (VHF), ultra-high frequency (UHF), or microwave ranges. Each type of electrodeless lamp requires some external means for applying the high frequency electromagnetic power to the plasma chamber or bulb, since there are no electrodes penetrating the bulb. Example lamp configurations in which the acoustic resonance modulation is deployed are shown in FIGS. 10-13.

In an example embodiment, means or circuitry is provided for tailoring the driving waveform, so that power is not only applied to the plasma lamp, but the power is modulated to excite specific acoustic modes (e.g., acoustic resonant modes). Acoustic resonance modes may be chosen to displace the arc from the position in a bulb normally found when exciting with the rectangular puck or lamp body when no acoustic modulation takes place. For example the plasma arc may hug a wall of the bulb closest to the lamp body. It is believed that in displacing and centering the arc within the bulb, a substantially more isothermal temperature profile may be achieved. This unanticipated temperature profile may provide annular regions in a cylindrical bulb where greater concentrations of molecular radiators exist in thermal equilibrium, and simultaneously are excited to emit useful, visible light. A more isothermal or homogeneous bulb wall temperature profile also simultaneously increases luminous efficacy of the plasma lamp while increasing usable plasma lamp lifetime. Homogeneity may relatively increase a temperature of the coldest spot inside the bulb, which may lead to higher vapor pressure of additive radiating materials, such as metal halide salts. At the same time, homogeneity may relatively decrease the temperature of the hottest spot inside the bulb, which may lead to longer product life through slower chemical reactions with the radiating additives, and also slower devitrification, of the bulb wall material. Example embodiments may provide improved performance as measured by the lumens per watt delivered by the lamp body, thus improving the efficiency of the light source while increasing life.

Example embodiments relate to a class of high intensity electric discharge light sources referred to as electrodeless lamps or plasma lamps, wherein the name implies there are no internal electrodes in a light transmissive bulb or plasma chamber; and, the energized medium is a gaseous mixture excited into a plasma state by the application of high frequency power. The high frequency power can be in the radio frequency (RF), high-frequency (HF), very-high frequency (VHF), ultra-high frequency (UHF) or microwave ranges, herein generally referred to as RF power.

Benefits of the electrodeless design may include eliminating stress in the fused silica bulb around electrode pierce points, improved maintenance due to lack of sputtered tungsten, reduced chemical reaction with electrodes or sealing components, and an ability to use chemistries which may be incompatible with electrode systems. While some example embodiments use a fused silica bulb, it should be noted that other lamp envelopes, plasma chambers, or bulbs may be fabricated from poly-crystalline sintered ceramics or single crystalline ceramics or other amorphous glasses. Such materials may include, but are not limited to, poly-crystalline alumina (PCA), poly-crystalline yttria, sapphire or aluminosilicate glasses.

Example embodiments provide an electrodeless lamp containing an ionizable fill, a lamp body providing a resonator for excitation, an electronic driver or power source to provide high frequency power in the range of 300 MHz to 1 GHz (or more) (e.g., about 440 MHz), and circuitry configured to pulse width modulate the power from the power source. The figures included herein should be considered schematic in nature, and it should be noted, that geometric changes may be made which are within the scope of the instant disclosure. For example, minor modifications to the size of the lamp body or changing from rectangular parallelepiped to cylindrical are considered within the scope of the instant disclosure.

Example embodiments may produce an electrodeless discharge with improved efficacy through the excitation of acoustic resonances. Further, Example embodiments may achieve selection of the desired resonances via pulse-width modulation (PWM). It is however to be appreciated various different modulation techniques may be employed to modulate an RF power signal to induce acoustic resonance in a plasma arc in an electrodeless plasma lamp.

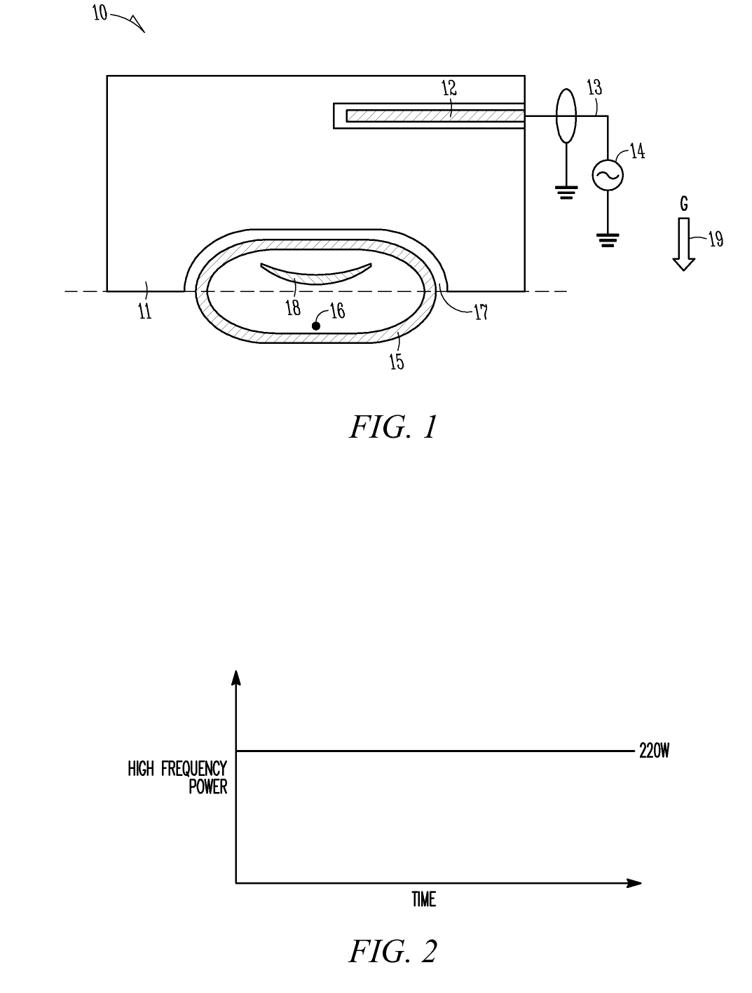

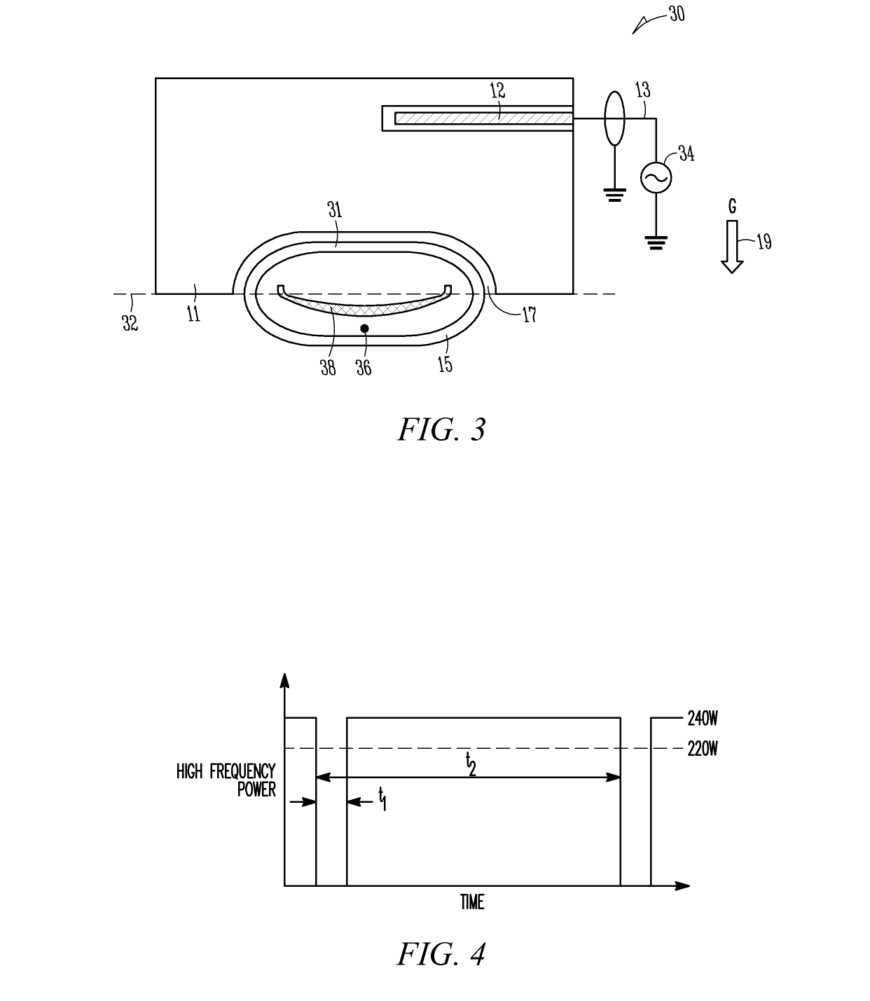

FIG. 1 shows an electrodeless plasma lamp 10, according to an example embodiment, operating under normal excitation in which steady state RF power is applied. A resonator lamp body 11 is energized by a coupling feed in the form of a probe 12 that is mated via a coaxial cable 13 to a high frequency power source 14. The power source 14 is shown by way of example to be a solid-state amplifier capable of producing in excess of 240 W of power at a frequency of approximately 440 MHz (RF Power carrier frequency). The lamp body 11 establishes an electromagnetic field in the vicinity of a bulb 15 that causes ionization of a fill gas, and by thermal losses, evaporation and further ionization of the vaporizable fill 16 contained inside the bulb 15. The bulb 15 may be in contact with the lamp body 11, or separated by a thin layer 17 of air or other higher dielectric material. At full operating temperature, a sustained arc 18 may be slightly bowed, but hugs an interior of the bulb 15 as shown in FIG. 1. Gravity is shown by an arrow 19 in FIG. 1 to indicate that the lamp body 11 is above the bulb 15. An example deployment of the orientation of the plasma lamp 10 is in street and area lighting. Further, as can clearly be seen in FIGS. 1 and 3, a portion of the bulb not received within the lamp body 11 may be exposed and protrude from the lamp body 11.

The type of operation depicted in FIG. 1 is achieved by excitation with unmodulated power (see FIG. 2). For example the power source 14 may provide power at a frequency of about 440 MHz with an envelope of the power not modulated. FIG. 3 shows the envelope of electromagnetic power provided by a power source 34 that modulates the power that is coupled to the bulb 15 via the cable 13 and the probe 12. For example, the power source 34 may provide power at a frequency of 440 MHz with pulse-width modulation (see FIG. 4).

In an example embodiment, the bulb fill is an inert gas, such as Ar, Kr, Xe or mixtures thereof at pressures in the range of about 1 to 1000 Torr, in addition to a dose of metallic mercury and one or more metal salts. The salts may be halides of the rare earths in combination with an indium halide. The halides may be iodine, which is used in electroded metal halide lamps, or bromine, or chlorine that is rarely used in electroded lamps because of reactions with the electrode materials. An example dose is 35 mg of Hg, 150 hPa of Ar, 0.5 mg of InBr, and 0.6 mg of TmBr₃ in a bulb of dimensions 6 mm interior diameter, and 15 mm interior length.

FIG. 3 shows the shape of the plasma arc 38 when the power is modulated (e.g., see FIG. 4) and applied through the cable 13 and the probe 12 and coupled to the bulb 15 via the lamp body 11. In an example embodiment the power is modulated by an electronic circuit which interrupts the carrier with chosen periodicity so the carrier (e.g., at a resonant frequency for the plasma lamp 10) is either on or off with an appropriate duty cycle. This is shown by way of example in FIG. 4, where an off time of the carrier modulation is designated as t₁, and the period is designated as t₂. In FIG. 3, the arc 38 is observed to move away from upper interior surface 31 of the bulb 15 and, in an example embodiment, the plasma arc 38 is spaced from a plane 32 of the lamp body 11. Accordingly, in an example embodiment, when power applied at a carrier frequency is modulated, a resulting plasma arc may be displaced outwardly towards an exposed side of the bulb (e.g., the bulb 15). The position of the plasma arc may thus, in some embodiments, be dependent upon modulation of an envelope of the power applied at a selected frequency (e.g., dependent upon the physical design of the lamp body) to the lamp body. It is believed that a radial acoustic pressure wave redistributes the evaporated material within the arc 38 and counteracts a buoyancy force. Because the arc 38 is in local thermal equilibrium, a spatial change in density may be accompanied by a spatial change in gas temperature, and so it is believed that more favorable temperature profiles are established in the arc 38 under PWM leading to increased visible radiation from the arc 38. For example, example tests show a relative increase in lumen output of 16.4% with this type of excitation using PWM. This may be accompanied by a reduction in a hot spot temperature of approximately 20° C., further indicating that a radial temperature homogenization occurred. This temperature homogenization in the bulb 15 and the gaseous contents with concurrent increase in light output may result from exciting the radial resonance acoustic resonance mode. A further result of the temperature homogenization from exciting the first radial mode was a lowering of the Color Correlated Temperature (CCT) of the plasma lamp to a more beneficial range for general lighting. In the example cited above, the CCT decreased by 300K when the power applied to the lamp body was pulse-width modulated. It should be noted that, although reference is made in the disclosure to PWM, other modulation techniques may also be applied and PWM is merely referenced as an example technique to modulate RF power at a carrier frequency and coupled into a lamp body of a plasma lamp.

The frequency of the applied PWM signal, or other type of modulation, f=1/t₂ (see FIG. 4), may be chosen to excite one selected acoustic resonance mode. It is somewhat unanticipated that the equations taught by Witting would be applicable to such a short bulb. Nevertheless, for the first radial mode Witting predicts,

$${f}_{r} = \frac{3.83 v}{2 π r} \qquad ( 1 )$$

Of course, the sound speed, v, must be estimated based on the assumed radial temperature profile. In an example embodiment, an average gas temperature of 2800K is assumed. In an example embodiment, the fundamental radial acoustic resonance, which creates pressure waves in the plasma that tend to gather the hottest, least dense material (the plasma core) at the geometric center axis of a cylindrical bulb, is approximately 89 kHz, and a strong beneficial response of the plasma lamp may be present at approximately this frequency. Accordingly, the PWM frequency may be equated to the first radial frequency to achieve the beneficial excitation of the fill in the bulb.

It should be noted that as the geometry of the bulb changes (r), or the average gas temperature that affects the sound speed within the bulb, the desired resonance will shift, but can be predicted from the relationship above. Example tests were performed on lamps with similar fill, but reduced radii, viz. 2.5 mm versus 3.0 mm. The differential frequency shift was computed by the variation in fᵣ:

$$\frac{δ {f}_{r}}{δ r} = - \frac{3.83 v}{2 π {r}^{2}} \qquad ( 2 )$$

The assumption for average gas temperature was preserved since the chemical constituents of the plasma remained the same. The new radial resonant frequency was then computed as:

Fᵣ=fᵣ+δfᵣ (3)

The new radial resonance frequency, Fᵣ=104 kHz, was thus predicted and subsequently measured in an example plasma lamp with bulb of reduced radius.

Many methods to impose acoustic modulation of the power applied to the lamp body may be employed. Amplitude modulation (AM) of a sine wave carrier, or frequency modulation (FM) of the carrier are two examples for exciting acoustic resonances in an electrodeless plasma lamp. However, AM or FM suffer from practical difficulties impeding implementation, such as substantially increasing the number and cost of additional circuit components, and power amplifier inefficiencies encountered when implementing these approaches. Accordingly, embodiments of the present disclosure may rely on pulse width modulation (PWM) to excite the desired acoustic modes in the bulb. The waveforms generated under PWM were briefly described by way of example above, and an example is depicted in FIG. 4. A duty factor (DF), or duty cycle (DC), is defined as a decimal (or fraction) related to the period, t₂, of the power envelope and the off time, t₁:

$$DF = 1 - \frac{{t}_{1}}{{t}_{2}} \qquad ( 4 )$$

Clearly, when t₁=0, an amplifier of the power supply is “on” continuously and the DF=1; when t₁=0.5 t₂, the DF=0.5; and, when t₁=t₂, the DF=0. In operation of example embodiments, the duty factor may be maintained between 0.5 to 1.0 and, in one example embodiment, between 0.8 and 0.99.

PWM may maintain a high overall system efficiency, viz. considering both the lamp body and RF power amplifiers used in the power source. In an example embodiment, the RF amplifier is either “on” and saturated (PWM=high), or “off” and not consuming power (PWM=low). PWM may be easier to generate with digital signal sources: multiplying a low frequency binary signal with the RF carrier. The enhanced plasma lamp efficiency preserved with PWM is consonant with the design considerations of example embodiments, namely, improving the Lumens Per Watt (LPW) of a plasma lamp. In an example embodiment, where PWM is used, the RF power is inherently 100% modulated and allows the RF power amplifier to remain saturated. This is in contrast to embodiments that use amplitude modulation of a sine wave where a modulation index is about 5% or greater that may be inefficient for some example lamps. When using amplitude modulation, the amplifier operates at maximum efficiency at peaks of the sine wave envelope but most of the time the amplifier is operating at a lower output (the zero crossings and troughs of the sine wave). With PWM, the RF amplitude is either at the max efficiency point, or zero. Accordingly, efficiencies of the power amplifier may be enhanced.

In an example embodiment, to enhance excitation the desired acoustic resonances, the frequency of modulation, f=1/t₂, may be adjusted to coincide with the selected radial frequency (first radial mode) as predicted by equation (1). The first radial mode, which is advantageous for centering the arc, is a descriptive term for the acoustic resonance that creates a radial pressure wave that may tend to gather the hottest part of the plasma at the center of the bulb by the following mechanism: The pressure wave, comprising variations in the plasma density, travels radially outward at a temperature dependent velocity of sound. The geometry of the bulb, particularly its cross-sectional geometry, and the plasma temperature profile determine a frequency for which the pressure wave is resonant. That is, for a given bulb geometry and plasma temperature, there will always exist some frequency for which a pressure wave that starts at radius=0 with maximum temperature and minimum density radiates outward toward the bulb wall, located at such a distance from center that the pressure wave will have minimum temperature and maximum density by the time it travels there. In short, the bulb inner radius corresponds to one half wavelength of the pressure wave. Upon reaching the wall, the wave reflects back toward the bulb center, although this time it will start its traverse at the wall with minimum temperature and maximum density. And it will arrive back at the bulb center with maximum temperature and minimum density. In this way, it may create a standing wave in the radial dimension that forces the hot material of the plasma core into the center of the bulb.

Other types of resonant modes also exist. Primarily these are longitudinal and azimuthal acoustic modes. They operate according to the same mechanism described above, where a standing wave is created along the relevant cylindrical dimension according to the bulb geometry and average plasma temperature in that dimension. The longitudinal modes, and in particular the higher-order longitudinal modes, were unexpectedly found to cause the plasma to become unstable. A longitudinal mode will tend to create a standing wave along the bulb axis which alternates plasma temperature between cold (high density) and hot (low density). The fundamental longitudinal mode may have little impact on the plasma, since it will tend to gather the hottest gaseous species toward the middle of the bulb axis, where it is intended to exist anyway by virtue of the design of the electrodeless discharge. However, higher order longitudinal modes are detrimental to plasma stability. Higher order longitudinal modes tend to gather the plasma into clumps of alternating cold and hot regions along the bulb axis. This is counter to the natural operation of the electrodeless discharge, and creates unstable flickering plasmas.

There are also mixed modes, which are combinations of longitudinal, radial, and azimuthal modes that exist at frequencies which are not easily predicted. Mixed modes arise when a pressure wave along one dimension encounters a discontinuity and reflects off it in a way such that a second pressure wave is created in another dimension. For example, a longitudinal mode that travels along the cylindrical axis of the bulb may encounter a non-uniformity or bump in the wall, or a complex-shaped seal at the very end of the bulb. This longitudinal mode, when it encounters the discontinuity, may devolve into a reflected longitudinal wave and also a reflected radial wave. There are many mixed modes verified by observing plasma instabilities at frequencies which are not attributable to longitudinal or radial modes by the relevant formulas, Based on observations in the course of this work it is expected that most of these mixed modes will cause the plasma to be unstable, since they are generated somewhat randomly by various discrepancies between the actual bulb shape and an ideal right circular cylinder for which all resonant modes are calculated.

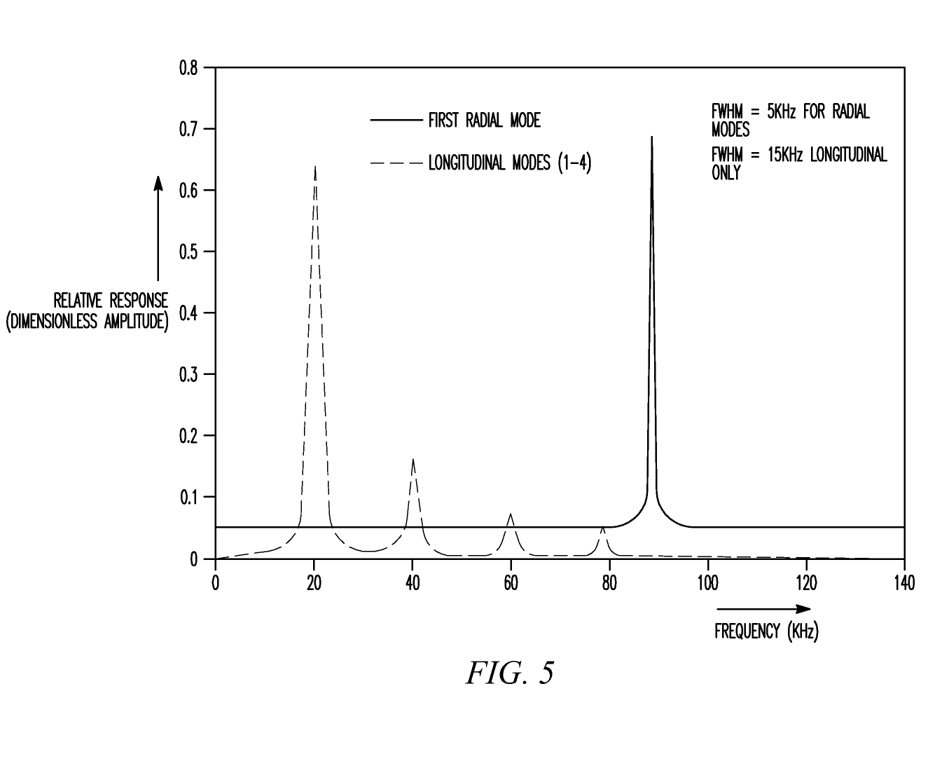

In example embodiments, it was unexpectedly found that the predicted frequencies are not precisely determined by equation (1), but encompasses a spread of frequencies about the value predicted by equation (1). It is believed that this is due to manufacturing tolerances in an example plasma lamp and, more particularly, in the formation of a seal near the end of the bulb which is controlled well, but exhibits some geometrical variances. These slight variations may contribute to a broadening of the overlapping longitudinal resonances that can perturb the functioning of the desired radial compression and rarefaction of the plasma. An example of such a calculated overlapping longitudinal resonances for an example lamp is shown in FIG. 5. A full width at half maximum (FWHM) for the longitudinal modes is larger than the FWHM of the radial mode since the variation or uncertainty in the overall length is greater than the variation in the internal diameter. Careful control of the seal shape used in the example plasma lamp may ensure enhanced consistency in length and reduce (e.g., minimize) the effect of the overlapping longitudinal modes.

In an example embodiment the first radial mode is selected for a substantially elongate bulb having, for example, an internal diameter of about 6 mm and internal length of about 15 mm. In some example embodiments, a ratio of an internal length to an internal diameter of the bulb may be from about 2:1 to 20:1. In example embodiments, the first radial mode has the effect of centering the plasma radially to counteract the force of gravity to improve a luminous efficacy of the bulb. Luminous efficacy may, for example, be increased in the following two ways. First, the arc may be pushed further out of the resonator or lamp body than it would be without acoustic resonance and, accordingly, more rays of light from the plasma directly exit the resonator without needing to bounce off a reflective surface first. Second, when the arc is centered in the bulb, the bulb wall may become more isothermal. The cold spot temperature increases for the same time-averaged input power, resulting in higher vapor pressures of evaporated radiating species (such as InBr and TmBr₃), and more efficient operation. With acoustic mode operation, a pool of condensed metal halides at the cold spot is smaller (more material evaporated). This may also increase luminous output from the lamp since the condensed pool at the cold spot is typically somewhat opaque to light transmission. A smaller pool may obstruct fewer rays exiting the bulb, and more light will be delivered from the product.

Because of the overlapping modes and the tendency of acoustic perturbations to cause redistribution of condensed material in general (and a possible associated redefinition of the unperturbed operating point) it was found that sweeping the excitation or modulation frequency about the nominal value (selected modulation frequency) may be an effective means of ameliorating these problems. In particular, it was found that the sweep range should be around the fundamental radial resonance and especially between 50 to 120 kHz. For example, in a cylindrical bulb of dimensions 6 mm internal diameter, with a 2 mm wall thickness, and an internal length of approximately 15 mm a sweep range of about 84 to 92 kHz may be selected. In an example embodiment, it was also found that a fast sweep (e.g. having a period of 10 milliseconds, or 100 Hz) of the modulation frequency over this range was preferable to a slower sweep (e.g. several seconds). In an example embodiment, this makes sense that the sweep time be fast with respect to condensate redistribution times (seconds), since macroscopic redistribution of the condensate could change the melt operating temperature and alter the plasma conditions which might shift the radial resonance frequency. In some example embodiments, the sweep range is covered in 10 ms, or an equivalent sweep rate of 100 Hz. In some example embodiments, the sweep range is covered in 20 ms. In some example embodiments, the sweep range is covered in a variable time. For example, in at least one embodiment, the sweep range is initially covered in 10 ms for some time after turning on the plasma lamp. If any instability is detected in the lamp, then the lamp controller in the power supply may dynamically slow down the sweep to 20 ms, or 50 Hz sweep rate. In some example embodiments the sweep waveform is a sawtooth, although a triangle shape (or other waveform shapes) could also be used. In an example embodiment, a difference between a frequency of the RF power is more than three decades from a frequency of the acoustic modulation. In an example system, the RF power also contains some degree of frequency modulation, such that it operates as what is commonly known as a spread-spectrum carrier. In at least one example embodiment, the RF power is at approximately 440 MHz, with PWM acoustic modulation at approximately 90 kHz, and spread-spectrum carrier frequency modulation at approximately 7.5 kHz. In an example embodiment, a difference between a frequency of the acoustic modulation is more than one decade from a frequency of the spread-spectrum carrier. This separation aims to avoid the spread-spectrum accidentally coupling power to undesired unstable longitudinal or mixed modes in the vicinity of the desired first radial mode.

In example embodiments, the swept modulation frequency approach is incorporated into the drive electronics of the power supply. In an example embodiment, so long as the sweep range is wide enough, production variances in the bulb may be accommodated by the drive electronics and the lamp body that obviates the need for tuning each individual bulb. It should be noted that any bulb may be placed into any lamp body with comparable operation. In a similar fashion, any bulb can be replaced into any lamp body in the unlikely event of bulb malfunction.

Returning to FIG. 3, in an example orientation, the plasma discharge forming the arc 38 may be pulled away from the lamp body 11 towards the center of the bulb 15 and, in some example embodiments, past the center of the bulb 15. This may result in more direct rays being accessible to optical control surfaces (such as reflective or refractive optical elements) which surround the light source, consequently allowing better formation and control of both the near and far field optical beam generated by the plasma lamp (e.g., the plasma lamp 10). Arc constriction (a narrowing of the diameter of the hottest portion of the arc), due to radial compression, may improve collection efficiency as the effective source brightness is increased. In an example embodiment, the modulation frequency may be high enough to at least reduce (ideally eliminate) observable flicker.

Arc centering also may improve the thermal profile of the bulb of the plasma lamp, cooling the hot spots where ends of the arc may impinge on a wall of the bulb and raising a temperature of the salt condensate. Cooling the hot spots may be beneficial since it may reduce reaction rates between the chemical fill and a wall of the bulb. For example, rare-earth metal halides such as HoBr₃, TmBr₃, and DyBr₃ all have highly desirable luminous radiation properties when operated in a plasma discharge. However they all react with quartz at high temperature (1000's of Kelvin), especially Ho from HoBr₃, and Dy from DyBr₃. In this way, using such fill chemicals may be possible in a substantially longer life product than would be possible without acoustic modulation. The bulb temperature redistribution may also heat the condensate a bit more and may generally improve lamp performance by adding additional radiating species into the plasma.

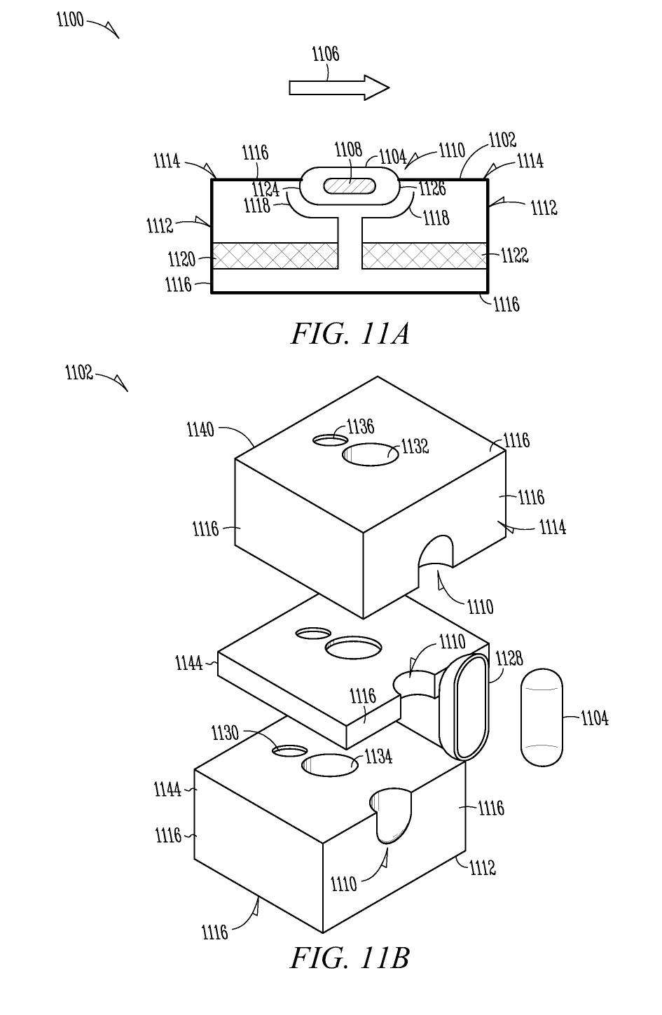

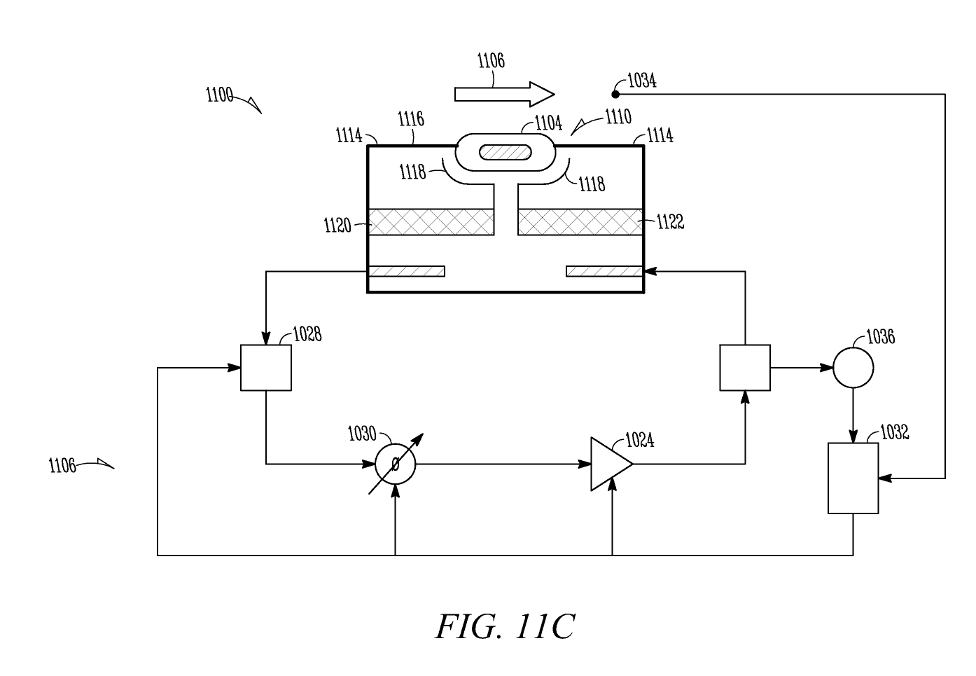

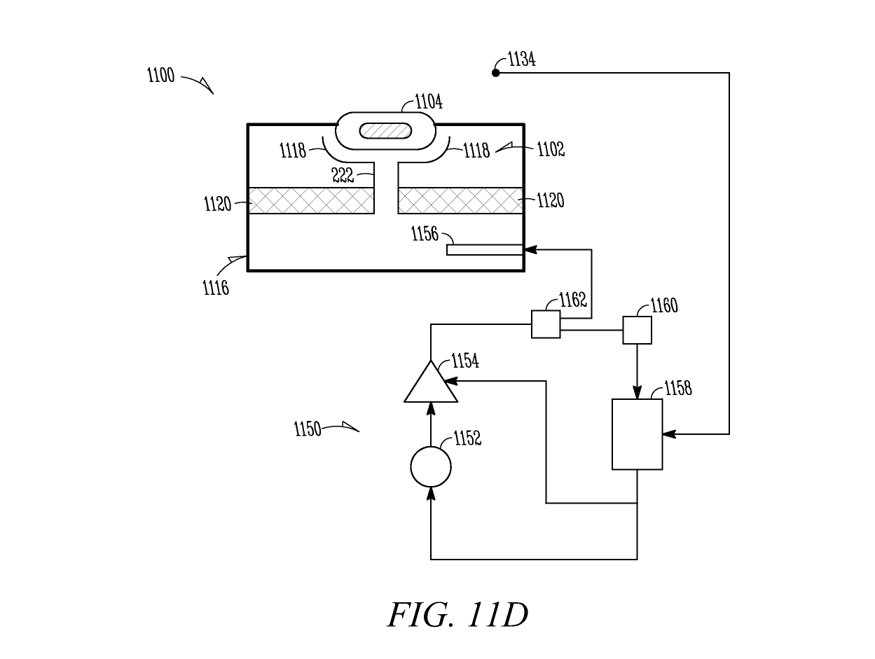

An example rectangular, alumina lamp body, or resonator, (e.g., see FIG. 11) may be used to excite a cylindrical lamp that is mounted such that the bulb's long axis is substantially parallel to the ground operated in accordance with one or more of the methods described herein. The lamp body may act as an impedance transformer to the bulb, and the bulb impedance itself is arc-position-dependent. When the arc is displaced via excitation of the appropriate acoustic modulation (e.g. at resonance for the bulb), the lamp body input impedance is changed slightly. An example of such a change is about 2-5 Ohms for a lamp body nominally tuned to about 50 Ohms. This is accompanied by a slight upward shift in the lamp body resonant frequency of about 0.5-0.8 MHz. In example embodiments, the lamp body tuning is not changed from the unperturbed (no acoustic resonance) tuning. Further improvements may be made if the lamp body input impedance is tuned to 50 Ohms during a PWM operating phase. In example embodiments, efficiency benefits might be further realized if the lamp body is tuned to 50 Ohms in an intermediate state, viz. at a duty cycle halfway between the target operating duty and 100% duty, which would minimize the tuning mismatch in going into either state.

The resonator or lamp body in some example embodiments is rectangular, solid alumina and parallelpiped with metalized sides (forming a metallic enclosure of a resonant structure) and coupling holes for an antenna (input power) and slots to couple the power to the bulb (e.g., the plasma lamp of FIG. 11). Other dielectric material could be used in place of the alumina (∈ᵣ≈10) with appropriate changes in size as the relative permittivity (∈ᵣ) of the material changes. Examples of other materials include ceramic material in general in either solid or powder form; metal oxide ceramics such as fused silica, sintered yttrium oxide (yttria), sintered dysprosium oxide (dysprosia); ceramic nitrides such as aluminum nitride and boron nitride; carbon based materials such as synthetic diamond; and liquid, gas and gel filled metal cavities such as a water-filled cavity. The resonators need not be rectangular parallelepipeds, but could have other geometric shapes such as spheres, ellipses of revolution, cylinders, tetrahedra, cones, etc. Accordingly, the example acoustic modulation methodologies described herein may be applied to plasma lamp with different shaped lamp bodies.

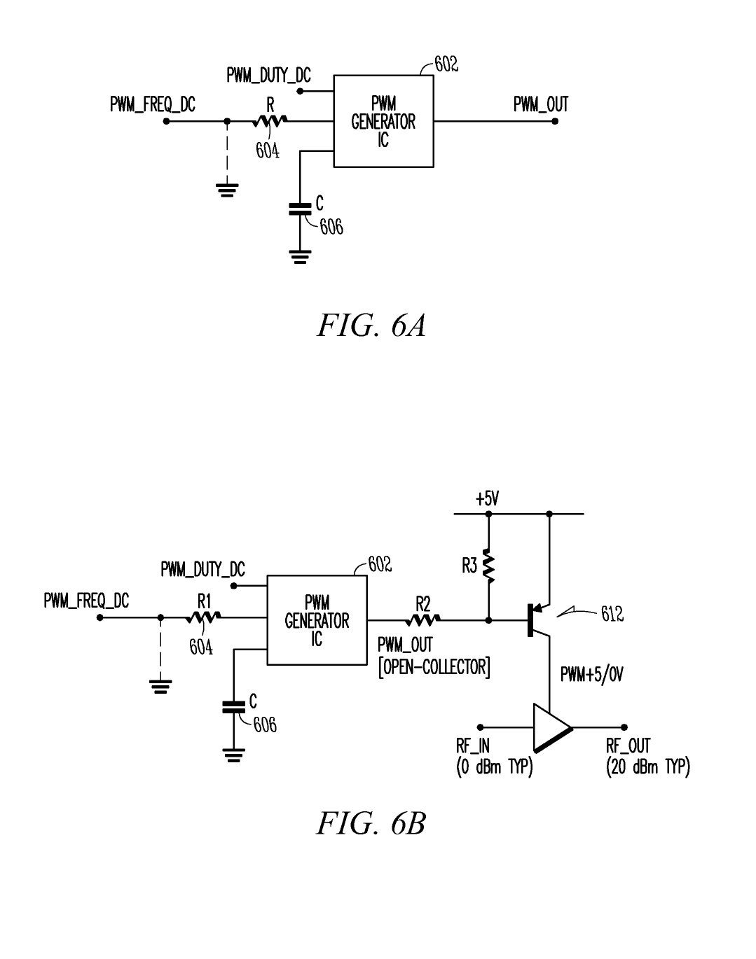

As described above, in an example embodiment the PWM functionality is embedded into the drive electronics of the power supply. An example of this integration is shown FIGS. 6A and 6B. Example embodiments may use an inexpensive dedicated PWM generation integrated circuit (IC) 602, such as the SG3525A from Microsemi. As shown in FIG. 6A, the IC 602 generates a PWM waveform with frequency set by external resistor (R) 604 and capacitor (C) 606 connected to an internal oscillator of the IC 602. The duty cycle of the power supply is proportional to a supplied input voltage (PWM_Duty_DC). Furthermore, the frequency can be modulated by disconnecting one side of R 604 from ground, and instead supplying a variable DC voltage (PWM_Freq_DC). An output of the PWM generator IC 602 (PWM_Out) has frequency and duty cycle, and it may be an open-collector signal for this class of IC 602, as opposed to a fixed voltage. The duty cycle of PWM_Out is proportional to PWM_Duty_DC. If R 604 is grounded, then a frequency of PWM_Out is fixed, and is inversely proportional to RC. If R 604 is ungrounded, and driven by PWM_Freq_DC, then the PWM_Out frequency is inversely proportional to PWM_Freq_DC. In example embodiments, this method requires temperature compensation to be applied to PWM_Freq_DC and PWM_Duty_DC to keep the corresponding PWM frequency and duty constant over wide temperature swings, such as −55 C to +85 C. Temperature compensation may be accomplished in the digital domain, by means of applying a calibrated offset from a lookup table to PWM_Freq_DC.

Referring to FIG. 6B, the PWM output from the power supply (PWM_Out) may be used to switch on/off the drain bias for a low-power gain stage via a bias switch 612 in an RF chain. In an example embodiment, the gain stage forming part of a RF power amplifier uses LDMOS technology. It should be noted that other high frequency transistors or chips may be used as the active elements in the power amplifier including GaAs, GaN, SiC, SiGe, and silicon CMOS or BiCMOS components. The example circuit shown in FIG. 6B may correspond to the power supply 14 shown by way of example in FIGS. 1 and 3.

In an example embodiment, the RF power amplifier may be generally tuned to higher peak output power during PWM operation than it would be if power is provided to the bulb in continuous wave (CW) fashion (no modulation). For example, in continuous wave operation, the power amplifier may output about 200 W. The power amplifier may be tuned to an available saturated power (Psat) of 220 W to provide for 10% headroom. In PWM operation, with an example duty cycle of about 85%, delivering about 200 W average output power requires the power amplifier to run at 235 W when PWM=high. To keep the 10% headroom, in an example embodiment, the power amplifier is tuned to Psat=260 W.

Another consideration for the power amplifier circuit is providing adequate charge storage on drain bias network of an RF power amplifier. This may be achieved by including additional capacitors on the drain voltage (e.g., main 28V or 48V input DC voltage) of the RF power amplifier. These charge storage components are intended to maintain constant drain voltage even under large swings in current associated with PWM operation. The capacitors may have a self-resonance frequency above 5 times the PWM frequency (roughly 445 kHz) to be able to respond quickly to the rapidly rising, square edges of the PWM waveform.

Some example embodiments use the method for generating the PWM waveform including aspects described above. In an example embodiment, an alternative method is used wherein a direct generation of the PWM waveform by a microcontroller is performed using a match timer method. The technique may use a COUNTER register and a MATCH register. A starting value is loaded into the COUNTER register, which counts down by a decrement value, e.g., 1, every clock cycle or every several clock cycles. Another starting value is also loaded into the MATCH register, with MATCH<COUNTER (t=0). When COUNTER==MATCH, then a corresponding pin on the microchip flips (e.g. 0→3.3V). When COUNTER==0, the same pin flops (3.3→0V). By setting COUNTER the PWM frequency (PWM_Freq=Clock_Freq/COUNTER) may be controlled. By setting MATCH the duty cycle (PWM_Duty=MATCH/COUNTER) may be controlled. Many microprocessors support this technique with dedicated register banks Two example microprocessors with this feature used in example embodiments are the PIC18F26K20 from Microchip™, and the LPC 1227 from NXP™. In example embodiments, an external pin on the microcontroller, corresponding to the match timer, substitutes for the PWM_OUT pin of the PWM generator IC 602 in FIG. 6B. In some example embodiments an additional buffer is required between the match timer pin and the bias switch 612 since the match timer pin is not likely to be open-drain (or open-collector) on a mass-market microcontroller. Since a microcontroller may be needed anyway to operate the plasma lamp, using one with a match timer output can reduce component count and system cost and complexity by eliminating the need for a secondary PWM generator IC.

In an example embodiment the entire RF signal generation and control, including PWM and all the functions of components shown in FIG. 6B, are integrated into a single mixed-signal system-on-chip (SoC). This SoC is a custom-designed application specific integrated circuit (ASIC) that contains RF signal generation and amplitude control, as well as PWM and spread-spectrum modulation controls, such that the RF output pin of the SoC already contains the PWM waveform, including swept modulation frequency.

In example embodiments some additional controls may be necessary to ensure stable operation. For example, the output of the power amplifier may be monitored for two quantities, ripple and volatility. Intentional ripple may be superimposed on a main DC current by wiggling the RF carrier frequency (approximately 440 MHz). The wiggle may define a “spread-spectrum”, and may be accomplished by a very simple frequency modulation. Example modulation parameters include 0.2% total modulation (1 MHz spreading of the spectrum for a 440 MHz carrier), at a rate of about 7.5 kHz with a triangle wave shape. The frequency wiggle may be enough to induce changes in the power amplifier efficiency at about 7.5 kHz, which results in a small amount of ripple on the main DC current at 7.5 kHz. We tune the PA and its output-matching network such that the maximum ripple occurs near the lamp body resonant frequency.

In example embodiments using PWM, the spread-spectrum may be spaced far away in frequency space. In an example embodiment, the frequency space is a decade or more. For example, with about a 85 kHz acoustic modulation used for an example plasma lamp, the spread spectrum frequency may be reduced to 7.5 kHz. A low-pass filter (LPF) may be added to a ripple detector to attenuate the 85 kHz ripple from the PWM. The same LPF may pass the 7.5 kHz ripple from the spread spectrum. This may allow a voltage-controlled oscillator (VCO) to keep tracking the lamp body resonant frequency when PWM is operating.

Volatility is a measure of the arc flicker that might occur if the applied frequency and duty cycle are not correct. With flicker, the main DC current may fluctuate, for example swinging by ±10% or more in very short times, (e.g., of the order of 100 ms). To quantify this, a measurement by the firmware Volatility (V) may be implemented. In an example embodiment, to calculate volatility, firmware measures current during 0.5 sec windows or “bins”. In each bin, the firmware calculates Bin_Swing(i)=Current_Max(i)−Current_Min(i), where “i” is the number of the current bin. If Bin_Swing(i)<Min_Threshold (=0.1 A), then Bin_Swing(i)=0. For example, four consecutive bins represent a set, and it takes 2 seconds to complete each set. The volatility is computed as:

V=Bin_Swing(1)+Bin_Swing(2)+Bin_Swing(3)+Bin_Swing(4).

If the current fluctuation in each of the four bins is less than Min_Threshold, then V=0. Volatility may provide an indication whether or not the arc is stable when it is pulled down (see FIG. 3). In example embodiments the measurement of analog signals (current, ripple, RF power, etc.) is synchronized with the PWM waveform. For example in an analog-to-digital convertor (ADC), sample time is wasted measuring such quantities when PWM==low. For example, consider current: when PWM==high, current might be approximately 10 A to the power amplifier; but when PWM==low, current might be <0.2 A. The ADC input may be tuned for enhanced accuracy at high current, while low current may carry an offset error. Without PWM synchronization, the ADC may be forced to measure both the high and low current values, and compute an average, which will have some built-in error. However, in an example embodiment, if the ADC cannot sample the current waveform significantly faster than the PWM frequency, then that error may be very large. An improved way to accurately measure current is to make the ADC sample the current only when PWM==high. Then it will capture only the large current, and average current can be calculated as Current_Avg=Current_High*Duty_Cycle_%.

In an example embodiment, sweeping the modulation frequency was important to using volatility as an error function for finding an optimum frequency. Without fast sweeping, the volatility in some example embodiments is binary. Accordingly, it was either zero or non-zero, and it may not be proportional to the difference between the immediate frequency at the time of measurement and the optimum frequency. This is because the desired first radial mode for example embodiments resided in a narrow range of stable frequencies surrounded above and below by immediately adjacent ranges of unstable frequencies. In some example embodiments, the unstable range immediately below the stable range, including the first radial mode, may cause the plasma to flicker visibly, and/or to lose the beneficial effect of acoustic modulation of centering the arc radially within the bulb. In some example embodiments, the unstable range immediately above the stable range including the first radial mode will cause the plasma to flicker violently and may even extinguish completely. Therefore, when slowly searching for the optimum frequency without fast sweeping, one could only discern whether one had moved the frequency too far into an unstable range. By the time the non-zero volatility associated with that unstable range was observed, the plasma arc had usually already become non-centered radially within the bulb, or completely extinguished. In either case, the entire process of initially setting the modulation frequency and duty cycle, described below, would need to be restarted from the beginning. This takes time, and tends to displease users of the technology who typically dislike flickering lamps, or lamps that shut off unexpectedly.

In an example embodiment, sweeping the modulation frequency relatively quickly over a range while stepping the range up or down in frequency may result an example plasma lamp only spending a short time in an unstable range of frequencies, should it happen to enter one. For example, consider a fast sweep with a range of 2,000 Hz and a sweep period of 10 milliseconds. If the range is stepped down such that the lowest 200 Hz of the total 2,000 Hz sweep (10%) extends into an unstable region, and the remaining 1,800 Hz of the total 2,000 Hz sweep range (90%) is in the stable region, then the example plasma lamp will only operate in the unstable region for 10% of 10 milliseconds, or 1 millisecond, before safely returning to the stable region for a full 9 milliseconds. This 1 millisecond in the unstable region may be too fast compared to the speed of arc flickering to meaningfully destabilize the plasma. However, when an edge of the fast sweep range enters the unstable region, a relatively small degree of volatility may be created even if the arc remains visibly stable to most observers. In fact, close inspection of the arc under optical magnification will show that it is in fact flickering slightly in these cases. The volatility increases as the sweep range extends further into the unstable region. Thus, in an example embodiment, introducing a fast sweep of the modulation frequency changes the volatility response from binary to proportional. This allows volatility to be used as an error function to correct the modulation frequency sweep such that it minimizes volatility in an example plasma lamp.

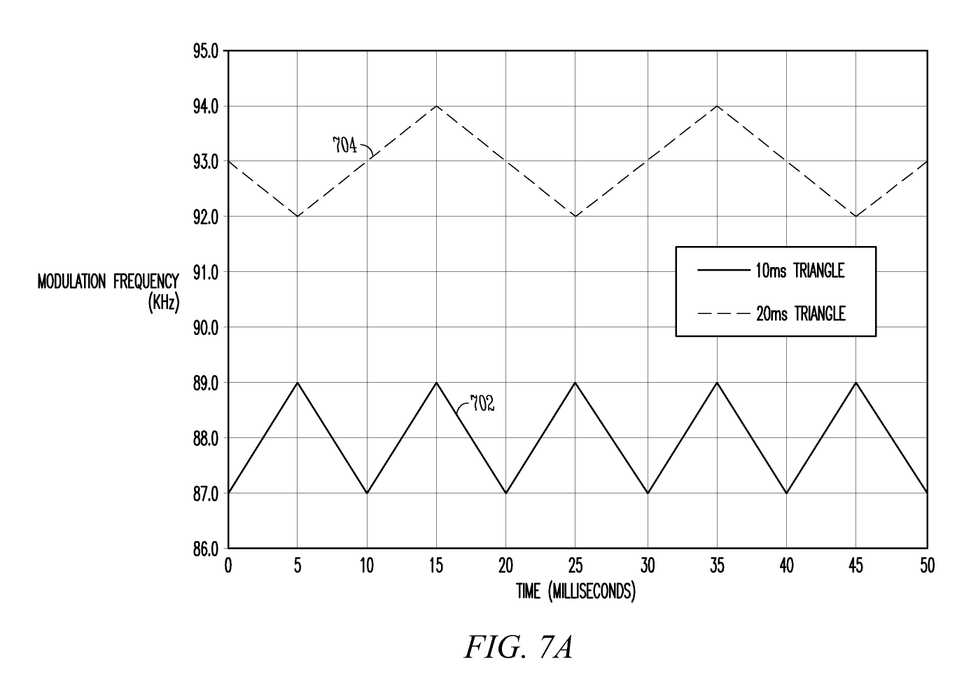

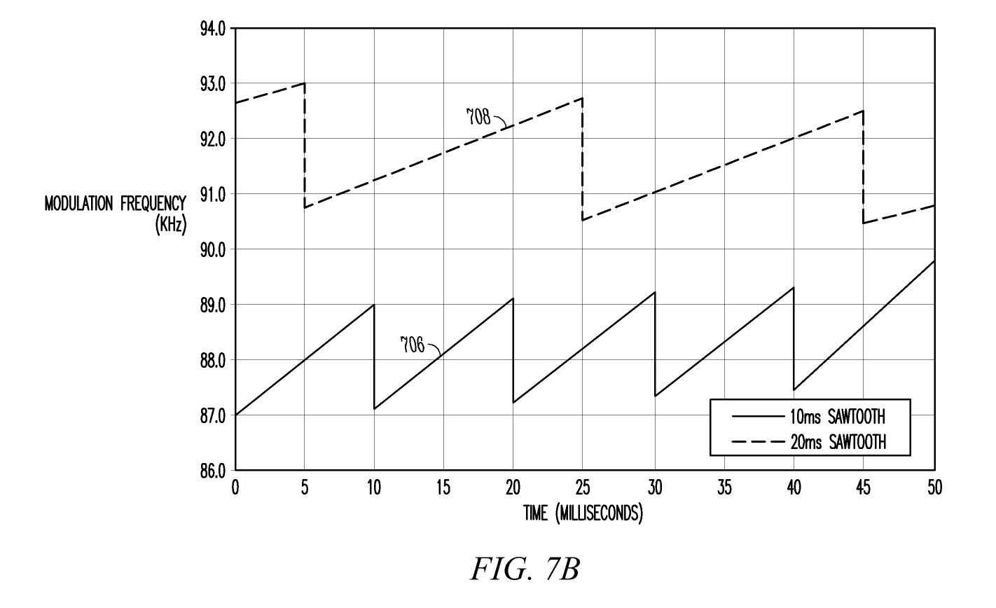

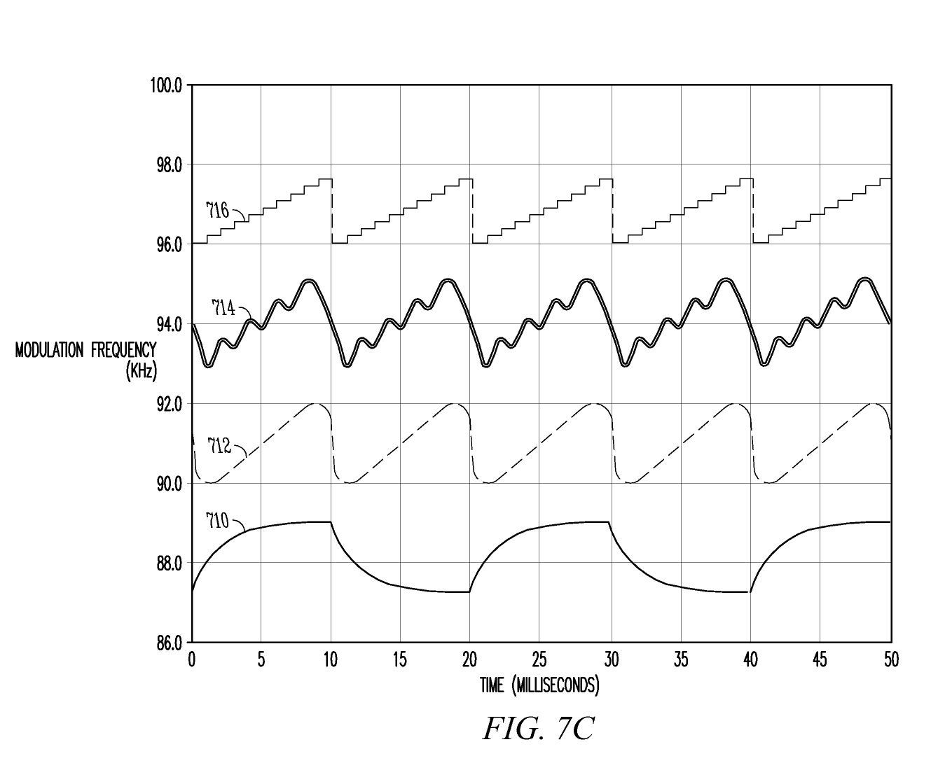

FIGS. 7A-7C show example waveforms to modulate RF power coupled to a lamp body of an electrodeless plasma lamp (e.g., the plasma lamps 10, 1000, 1100, and 1200).

The vertical axes of FIGS. 7A-7C show a modulation frequency in KHz and the modulation may apply to example bulbs described herein. For example, the example modulation shown in FIGS. 7A-7C may be suitable for a bulb with a nominal internal diameter about 6 mm that may create a first radial mode resonance in the range of about 80-100 kHz. The example modulation waveforms shown in FIG. 7A are triangular waveforms with a period of 10 ms (see waveform 702) and a period of 20 ms (see waveform 704). The example modulation waveforms shown in FIG. 7B are sawtooth waveforms with a period of 10 ms (see waveform 706) and a period of 20 ms (see waveform 708). The example modulation waveforms shown in FIG. 7C include a sharkfin waveform 710, a rounded sawtooth waveform 712, a dual frequency rounded sawtooth, 714 and a staircase waveform 716.

An example embodiment uses the rounded sawtooth and dual-frequency rounded sawtooth. An example embodiment using the match timer method described above uses the staircase, although with a very fine resolution so it approximates a standard sawtooth. An example embodiment using a SoC ASIC also uses a finely stepped staircase that approximates a sawtooth.

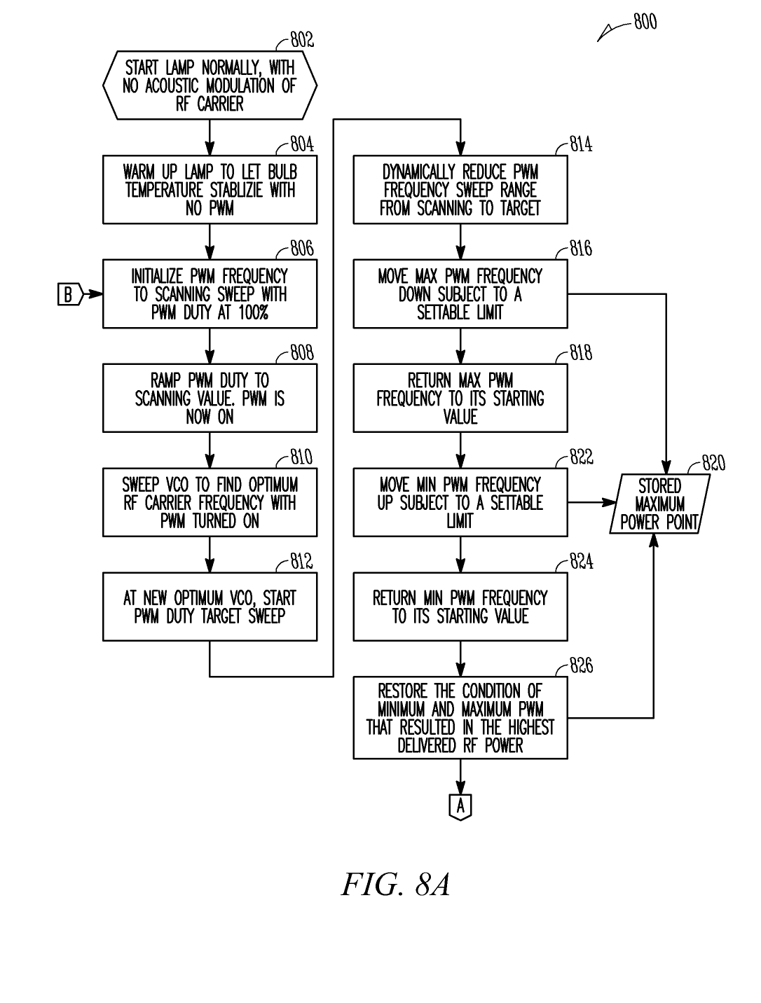

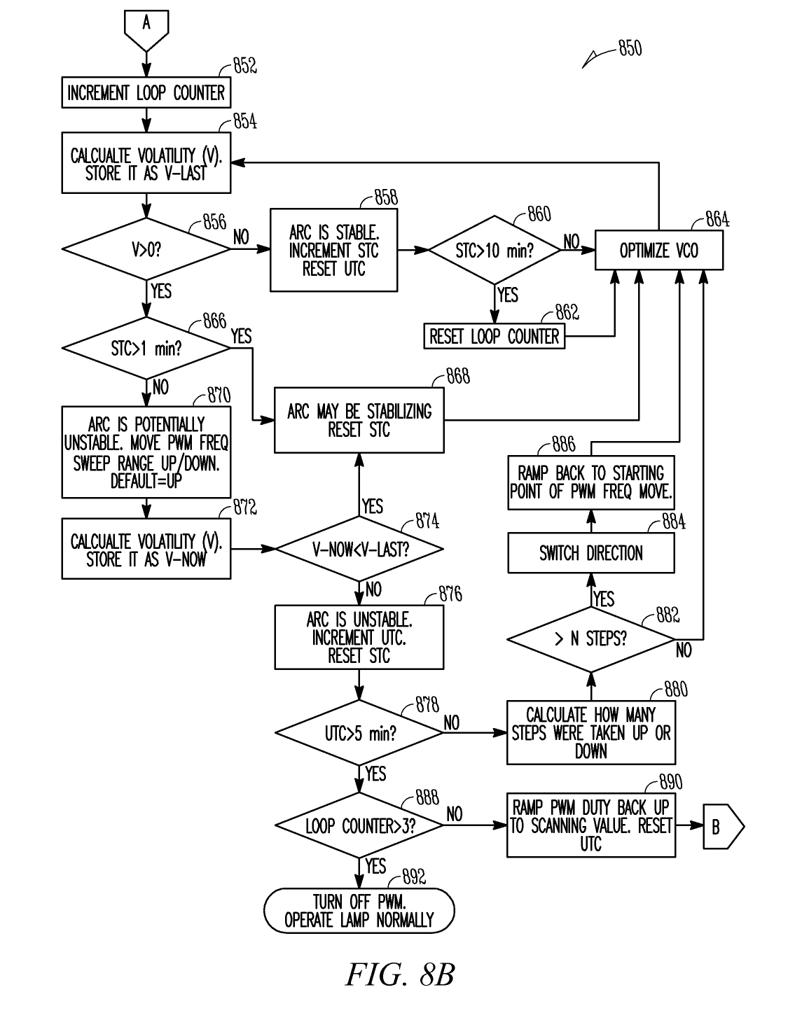

Referring to FIG. 8, a flowchart of an example method 800 (e.g., performed by a firmware instructions) is shown. The method 800 may be deployed on any electrodeless plasma lamp (e.g., the plasma lamps 10, 1000, 1100, and 1200). As shown at operation 802, the plasma lamp is started normally without PWM, and allowed to warm up for some period of time to allow the temperature to stabilize (see operation 804). Accordingly, as shown in operation 806, the PWM frequency may be configured to sweep the modulation range with a 100% duty cycle.

In an example embodiment, a warm up time of about 2 min is used, although this could be as short as 0 min or as long as 20 min (or longer). Short warm up times may not adequately establish a temperature profile in the plasma close to the final temperature profile, so an acoustic resonant frequency will be very different between the time when acoustic modulation is turned on and a time acoustic mode operation reaches stable performance. In an example embodiment, a long warm up time may be undesirable because the acoustic mode initiation typically causes the plasma lamp to flicker slightly. Users of this technology may not notice or mind a brief, slight flicker shortly after initial warm up. But if the flicker occurs 20 min in to normal operation, then it tends to be more noticeable since users will expect the plasma lamp to have reached stable operation by that point.

The PWM frequency sweep may be first initialized by setting sweep parameters, for example, PWM_freq_start, PWM_freq_stop, and PWM_freq_period. For an initial sweep, called the scanning sweep, in an example embodiment the PWM frequency range is chosen to be wider than is typically needed to operate a bulb. Example start and stop values of the sweep are 80 kHz to 93 kHz. PWM_freq_period may be 10 ms (100 Hz), and in an example embodiment this period does not change over the course of the PWM operation. This initialization may be done entirely in software. In an example embodiment, the hardware PWM generation is implemented with a PWM IC or a match timer forming part of the power supply.

In an example embodiment, PWM operation is effectively turned on by reducing the duty cycle from 100% (PWM off) to some reduced value. The duty cycle is first set to the scanning value, which may be 97% (see operation 808). In an example embodiment, the scanning value is higher than what is necessary for normal operation because it will be used while scanning the RF generator VCO through a range of frequencies. At some of these frequencies, the RF power amplifier will barely be able to deliver enough power to keep the arc from self-extinguishing. So a high duty cycle may be necessary to keep the delivered power high enough for the plasma lamp to stay on.

Once PWM is on, the optimum VCO frequency of the RF power from the power supply may not be the same. Experimentally, it was found for a test plasma lamp that an optimum VCO frequency of the RF power may be approximately 0.5 MHz higher with PWM than without PWM of the RF power. So the VCO may be optimized to find the point of highest delivered RF power with PWM on. As shown at operation 810, a controller may sweep a VCO, of the power supply, to find an enhanced (ideally optimum) RF carrier frequency of the power coupled to the lamp body. During this operation PWM may be turned “on”, but the duty cycle is only at its scanning value, which is not low enough to fully excite the first radial mode. Thereafter finding the optimum RF carrier frequency with some nominal duty cycle running, as shown at operation 812, an example embodiment switches to its final duty cycle, typically 92% before starting to sweep the acoustic modulation frequency over its range.

In an example embodiment, upon finding and returning to the optimum RF frequency, only then is the duty cycle reduced down to its target range for normal acoustic mode operation. The fixed duty cycle may be turned into a sweep similar to the PWM frequency sweep. The PWM duty sweep may have three parameters: PWM_duty_start, PWM_duty_stop, and PWM_duty_period. In an example embodiment, at first, PWM_duty_start may be equal to PWM_duty_stop, both set at the scanning value for duty cycle. The PWM_duty_period may be 5 ms, and may not change during acoustic mode operation. To set the PWM duty cycle from the scanning range to the target range, the PWM_duty start may be ramped down to its target value, for example 85%, while keeping PWM_duty_stop at the scanning value, typically 92%. Then the PWM_duty_stop may be ramped down to its own target, for example 88%. In this way, a fixed duty cycle may be gradually transitioned to a ramp without introducing any abrupt changes in power delivered to the plasma, which could otherwise cause it to self-extinguish (see operation 814).

Next the PWM_freq_start and PWM_freq_stop parameters may be dynamically adjusted from the generic pre-programmed values to values more suitable for the bulb being driven. As shown at operation 816, first PWM_freq_stop may be ramped down from its initial value (e.g., a maximum) to a final value (e.g., a minimum). During the ramp, which may require 5 to 10 s to complete, a microcontroller may monitor RF power delivered to the lamp, or a proxy for RF power delivery. The value of PWM_freq_stop that gives max power, as well as the power itself, may be saved (see operation 820). PWM_freq_stop may be reset to its maximum value, and the process may be repeated for PWM_freq_start. First PWM_freq_start may be ramped up from its initial value (e.g., a minimum) to a final value (e.g., a maximum) as shown in operation 822. During the ramp, which may require 5 to 10 sec to complete, the microcontroller may monitor RF power delivered to the plasma lamp, or a proxy for RF power delivery. The value of PWM_freq_start that gives max power, as well as the power itself, may be saved (see operation 820). Between the two value power points (e.g., maximum power points), the microcontroller may choose the higher one, and returns the PWM_freq sweep to the settings that produced the highest power (see operation 824). At this point, the lamp has completed its scan. In an example embodiment, the PWM frequency sweep now covers a range that is sufficiently close to the final range needed for stable operation. At this point, the lamp may exhibit some slight flicker, which will subside during the final PWM frequency range optimization.

FIG. 8B shows an example of a method 850 for PWM frequency sweep range optimization starting from marker “A”. First, as shown at operation 852, a loop counter is incremented from 0 to 1, to indicate the first time entering operation starting from marker “A”. Subsequent re-entries of the method from “A” will further increment the counter.

As shown at block 854, volatility (V) is calculated, for example as described in the above using, for example, a set of four bins, where each bin is shown to comprise a 0.5 sec sampling of the DC current to find the minimum and maximum current. The Volatility value is saved as V-last. High volatility corresponds to an unstable arc, and the PWM frequency may need to self-adjust to minimize volatility.

An example simple case to consider within the flowchart is when V==0. Then the (V>0?) decision operation 856 will evaluate as “NO”, and the arc is determined to be stable. No adjustment to the PWM frequency is necessary, and the stable time counter (STC) is incremented as shown at operation 858. At the same time an unstable time counter (UTC) is reset to zero. If the STC is >10 min (see decision operation 860), then the arc has been continuously stable for at least 10 min, and the loop counter is reset to zero (see operation 862). That means the control loop will not exit entirely to non-acoustic mode operation if it ever gets to the operations in the bottom of the flowchart. The method continues to the VCO optimization step (see operation 864), which is where almost all operations in the flowchart converge. The VCO optimization moves the VCO a few steps (an example step size is approximately 0.05 MHz) to try to increase RF power delivery to the bulb.

For V>0 (see decision operation 856), the method flow is more complex. The first situation to consider is when the STC>1 min (see decision operation 866). This means that the arc was previously stable with V==0 for at least 1 min. For this condition, a single instance of V>0 may be a random non-recurring event, or “blip”. Adjusting the PWM frequency in response to such a blip could actually cause additional instability since the lamp is otherwise stable at the present PWM frequency sweep settings. If the STC is greater than 1 minute, then no change is made to PWM the frequency sweep, but the STC is reset to zero (see operation 868). Due to the reset, if V>0 next time, it will represent 2 or more consecutive non-zero volatilities, which means the PWM frequency sweep truly needs to be adjusted. After operation 868 the method 850 proceeds to operation 864.

If V>0, and STC<1 min, then the arc is potentially unstable, and the PWM frequency range needs to be adjusted. The range is moved up or down, with the default being up for the first time through the control loop (see operation 870). Moving the range amounts to adding a fixed offset to the PWM frequency sweep parameters: PWM_freq_start(new)=PWM_freq_start(old)+Delta, and PWM_freq_stop(new)=PWM_freq_stop(old)+Delta, where Delta may be +/−0.2 kHz. After the move, as shown at operation 872 volatility is recalculated using, for example, the same binning procedure as before. As shown at operation 874, the new volatility (V-now) is compared to the old value (V-last). If V-now<V-last, then the arc stability is improving and the method 850 proceeds to operation 868. However, the arc is not yet confirmed to be stable, STC is reset to zero as shown at operation 876. Since the direction the PWM frequency moved produced a beneficial reduction in volatility, it is maintained. That is, if the method 850 forming a control loop returns along the same path on the next iteration, and PWM frequency went up last time, it will go up again. Then the VCO is optimized and the loop is started again.

If V-now>V-last, then the change in PWM frequency was not beneficial. It is assumed that the arc became more unstable as a result of the change. The UTC is then incremented (see operation 876). If the UTC is >5 min (see decision operations 878), then the control loop of the method 850 has been running for 5 minutes with no UTC reset, which means the PWM frequency optimization may not be working. In that case, the procedure is to start over by ramping the duty cycle back up to the scanning value (see operation 890), and returning to the PWM frequency initialization (see operation 806). As shown at decision operation 888, if the loop counter is <3, then the method 850 ramp the duty cycle of the PWM back up to the scanning value and resets the UTC (see operation 890). The method 850 then reverts to operation 806 of the method 800 (see FIG. 8A) as indicated by marker “B”. If the loop counter is 3 or greater (see decision operation 888), then that means the plasma lamp has had 3 consecutive iterations of the entire loop with no period of STC>10 min. In other words, it is assumed that the plasma lamp was never stable for 10 minutes so as to reset loop counter, and the control loop was not successful at optimizing PWM frequency. In this case, acoustic mode operation may be considered to be a total failure, and the control loop exits to normal lamp operation with no PWM. Accordingly, as shown at operation 892, PWM is turned off and the plasma lamp is operated normally without PWM.

If V-now>V-last, and UTC is <5 min, then the PWM frequency change was not beneficial, but it still has time to improve. The control loop now decides whether to change direction for next time. It considers how many steps were taken in the same direction, and compares that against a limit, N, which is typically 5. If the number of steps taken is >N, then the direction the PWM frequency moves is switched for next time, and the PWM frequency range is moved back to the starting point from where it originated. That is, if it started moving UP from a Delta=0, and it gets to Delta=5 (N steps, N==5) with no instance of V==0, then it switches direction to DOWN, and returns the frequency range to Delta=0. In this way, the method 850 may enhance or optimize the PWM frequency until stability is achieved, or it times out and abandons acoustic mode of operation.

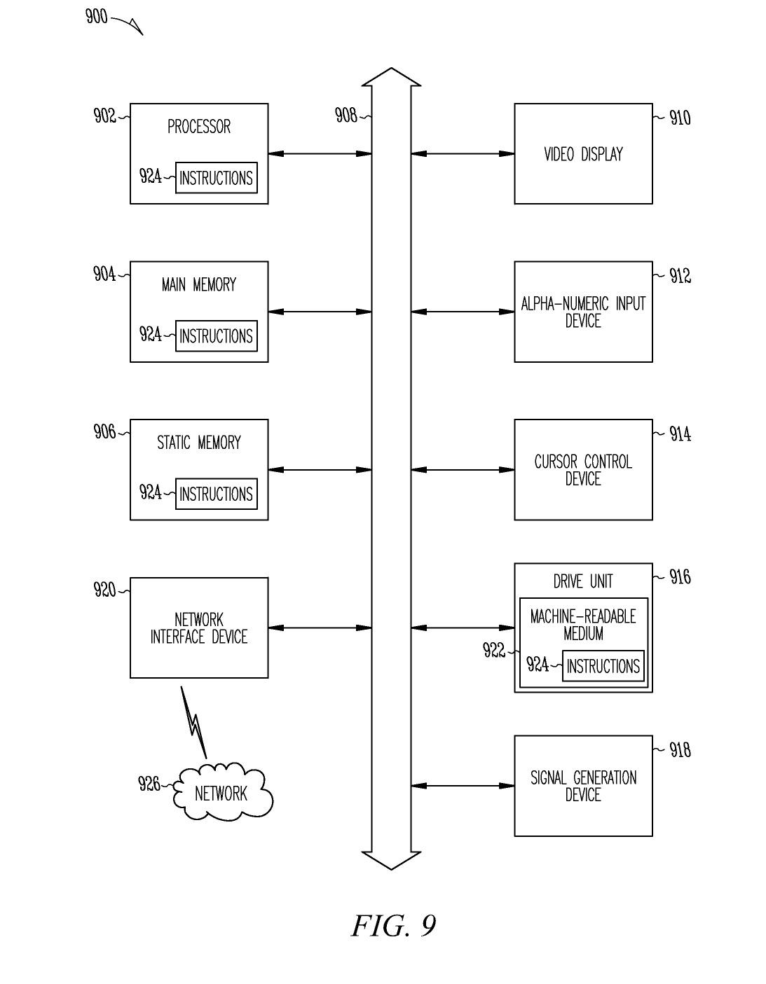

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system (microcontroller or otherwise) and within which instructions 924 (e.g., software) for causing the machine 900 to perform any one or more of the methodologies discussed herein may be executed. The machine 900 may be any processor-based system programmable to execute instructions to perform acoustic modulation or control of a power supply that drives a plasma lamp body (e.g., the example plasma lamp bodies described herein). While only a single machine is illustrated, the term “machine” shall also be taken to include a collection of machines that individually or jointly execute the instructions 924 to perform any one or more of the methodologies discussed herein.

The machine 900 is shown by way of example to include a processor 902 (e.g., a central processing unit (CPU), a microcontroller, an application specific integrated circuit (ASIC), or any other suitable processor capable, at least in part, of performing acoustic modulation), a main memory 904, and a static memory 906, which are configured to communicate with each other via a bus 908. The machine 900 may further include a graphics display 910. The machine 900 may also include an alphanumeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 via the network interface device 920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media able to store instructions. The term “machine-readable medium” shall also be taken to include any medium that is capable of storing instructions (e.g., software) for execution by a machine (e.g., machine 900), such that the instructions, when executed by one or more processors of the machine (e.g., processor 902), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Example Plasma Lamp with Vertical Bulb

FIG. 10A shows a schematic cross-sectional view of a plasma lamp 1000 according to an example embodiment. In an example embodiment, the methodologies described herein of modulating a carrier wave that provides power to a plasma lamp are deployed in the plasma lamp 1000. The plasma lamp 1000 may have a lamp body 1002 formed from one or more solid dielectric materials and a bulb 1004 positioned adjacent to the lamp body 1002. The bulb 1004 may contain a fill that is capable of forming a light emitting plasma when power is coupled to the fill. A lamp drive circuit 1006 may couple radio frequency power into the lamp body 1002 which, in turn, may be coupled to the fill in the bulb 1004 to form the light emitting plasma. In example embodiments, the lamp body 1002 forms a waveguide that may contain and guide the radio frequency power. The radio frequency power may be provided at or near a frequency that resonates within the lamp body 1002. The radio frequency power may then be modulated using one or more of the methods described herein.

In example embodiments, the lamp body 1002 has a relative permittivity greater than air. The frequency required to excite a particular resonant mode in the lamp body 1002 may scale inversely to the square root of the relative permittivity (also referred to as the dielectric constant) of the lamp body 1002. As a result, a higher relative permittivity may result in a smaller lamp body 1002 required for a particular resonant mode at a given frequency of power. The shape and dimensions of the lamp body 1002 may also affect the resonant frequency. In an example embodiment, the lamp body 1002 is formed from solid alumina having a relative permittivity of about 9.2. In some example embodiments, the dielectric material may have a relative permittivity in the range of from 2 to 100 or any range included therein, or an even higher relative permittivity. The lamp body 1002 may be rectangular, cylindrical or any other shape as described further below.

In example embodiments, the outer surfaces of the lamp body 1002 may define a conductive housing or enclosure. For example, the outer surfaces of the lamp body 1002 may be coated with an electrically conductive coating 1008, such as electroplating or a silver paint or other metallic paint that may be fired onto the outer surface of the lamp body 1002. The electrically conductive coating 1008 (conductive boundary) may be grounded to form a boundary condition for the radio frequency power applied to the lamp body 1002. The electrically conductive coating 1008 may help to contain the radio frequency power in the lamp body 1002. Regions of the lamp body 1002 may remain uncoated to allow power to be transferred to and/or from the lamp body 1002. For example, the bulb 1004 may be positioned adjacent to an uncoated portion of the lamp body 1002 to receive radio frequency power from the lamp body 1002.

In the example embodiment shown in FIG. 10A, an opening 1010 is shown to extend through a thin region 1012 of the lamp body 1002. Surfaces 1014 of the lamp body 1002 in the opening 1010 may be uncoated and at least a portion of the bulb 1004 may be positioned in the opening 1010 to receive power from the lamp body 1002. In example embodiments, the thickness 1011 of the thin region 1012 may range from 1 mm to 10 mm or any range subsumed therein and may be less than the outside length and/or interior length of the bulb 1004. One or both ends of the bulb 1004 may protrude from the opening 1010 and extend beyond the electrically conductive coating 1008 on the outer surface of the lamp body 1002. In other example embodiments, all or a portion of the bulb 1004 may be positioned in a cavity extending from an opening on the outer surface of the lamp body 1002 and terminate in the lamp body 1002. In other embodiments, the bulb 1004 may be positioned adjacent to an uncoated outer surface of the lamp body 1002 or in a shallow recess formed on the outer surface of the lamp body 1002. In some example embodiments, the bulb 1004 may be positioned at or near an electric field maximum for the resonant mode excited in the lamp body 1002.

The bulb 1004 may be quartz, sapphire, ceramic or other material and may be cylindrical, pill shaped, spherical or other shape. In one example embodiment, the bulb 1004 is cylindrical in the center and forms a hemisphere at each end. In one example, an outer length (from tip to tip) is about 15 mm and the outer diameter (at the center) is about 5 mm. In this example, an interior of the bulb 1004 (which contains the fill) has an interior length of about 9 mm and an interior diameter (at the center) of about 2 mm. The wall thickness is about 1.5 mm along the sides of the cylindrical portion and about 2.25 mm on one end and about 3.75 mm on the other end. In other example embodiments, the bulb 1004 may have an interior width or diameter in a range between about 2 and 30 mm or any range included therein, a wall thickness in a range between about 0.5 and 4 mm or any range included therein, and an interior length between about 2 and 30 mm or any range included therein. These dimensions are examples only and other embodiments may use bulbs having different dimensions.

The fill may include a noble gas and a metal halide. Additives such as Mercury may also be used. An ignition enhancer may also be used. A small amount of an inert radioactive emitter such as Kr₈₅ may be used for this purpose. In other embodiments, different fills such as Sulfur, Selenium or Tellurium may also be used. In some examples, a metal halide such as Cesium Bromide may be added to stabilize a discharge of Sulfur, Selenium or Tellurium.

In some example embodiments, a high-pressure fill is used to increase the resistance of the gas at startup and an inert starting gas my be included in the fill. This can be used to decrease the overall startup time required to reach full brightness for steady state operation. In one example, a noble gas such as Neon, Argon, Krypton or Xenon is provided at high pressures between 100 Torr to 3000 Torr or any range subsumed therein. Pressures less than or equal to 760 Torr may be desired in some embodiments to facilitate filling the bulb 104 at or below atmospheric pressure. In some example embodiments, pressures between 400 Torr and 600 Torr are used to enhance starting. Example high-pressure fills may also include metal halide and Mercury that have a relatively low vapor pressure at room temperature. An ignition enhancer such as Kr₈₅ may also be used. In a particular example, the fill includes 1.608 mg Mercury, 0.1 mg Indium Bromide and about 200 nanoCurie of Kr₈₅. In this example, Argon or Krypton is provided at a pressure in the range of about 100 Torr to 600 Torr, depending upon desired startup characteristics. Initial breakdown of the noble gas may more difficult at higher pressure, but the overall warm up time required for the fill to fully vaporize and reach peak brightness may be reduced. The above pressures are measured at 22° C. (room temperature). It is understood that much higher pressures may be achieved at operating temperatures after the plasma is formed. These pressures and fills are examples only and other pressures and fills may be used in other embodiments.

A layer of material 1016 may be placed between the bulb 1004 and the dielectric material of lamp body 1002. In example embodiments, the layer of material 1016 may have a lower thermal conductivity than the lamp body 1002 and may be used to optimize thermal conductivity between the bulb 1004 and the lamp body 1002. In some embodiments, a dielectric material such as a glass frit may be provided to reduce arcing proximate the bulb 1004.

In example embodiments, the plasma lamp 1000 has a drive probe 1020 inserted into the lamp body 1002 to provide radio frequency power to the lamp body 1002. In the example of FIG. 10A, the lamp 1000 is also shown to include an optional feedback probe 1022 inserted into the lamp body 1002 to sample power from the lamp body 1002 and provide it as feedback to the lamp drive circuit 1006. In an example embodiment, the probes 1020 and 1022 may be brass rods glued into the lamp body 1002 using silver paint. In other example embodiments, a sheath or jacket of ceramic or other material may be used around the bulb 1004, which may change the coupling to the lamp body 1002. Other radio frequency feeds may be used in other embodiments, such as microstrip lines or fin line antennas.

The lamp drive circuit 1006 is shown to include a power supply, such as an amplifier 1024, coupled to the drive probe 1020 to provide the radio frequency power. The amplifier 1024 may be coupled to the drive probe 1020 through a matching network 1026 to provide impedance matching. In an example embodiment, the lamp drive circuit 1006 is matched to the load (formed by the lamp body 1002, bulb 1004, and plasma) for the steady state operating conditions of the lamp 1000. The lamp drive circuit 1006 may be matched to the load at the drive probe 1020 using the matching network 1026.

A high efficiency amplifier may have some unstable regions of operation. The amplifier 1024 and phase shift imposed by the feedback loop of the lamp drive circuit 1006 may be configured so that the amplifier 1024 operates in stable regions even as the load condition of the lamp body 1002 changes. The phase shift imposed by the feedback loop may be determined by the length of the loop (including matching network 1026) and any phase shift imposed by circuit elements such as a phase shifter 1030.

In example embodiments, radio frequency power may be provided at a frequency in the range of between about 0.1 GHz and about 10 GHz or any range included therein. The radio frequency power may be provided to the drive probe 1020 at or near a resonant frequency for lamp body 1002. The frequency may be selected based on the dimensions, shape and relative permittivity of the lamp body 1002 to provide resonance in the lamp body 1002. In example embodiments, the frequency is selected for a fundamental resonant mode of the lamp body 1002, although higher order modes may also be used in some embodiments. In other example embodiments, power may be provided at a resonant frequency and/or at one or more frequencies within 1 to 50 MHz above or below the resonant frequency or any range included therein. In another example embodiment, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the amplifier 1024 may be operated in multiple operating modes at different bias conditions to improve starting and then to improve overall amplifier efficiency during steady state operation. For example, the amplifier may be biased to operate in Class A/B mode to provide better dynamic range during startup and in Class C mode during steady state operation to provide more efficiency. The amplifier 1024 may also have a gain control that can be used to adjust the gain of the amplifier 1024. The amplifier 1024 may further include either a plurality of gain stages or a single stage.

In various examples, the feedback probe 1022 is coupled to the input of the amplifier 1024 through an attenuator 1028 and phase shifter 1030. An attenuator 1028 is used to adjust the power of the feedback signal to an appropriate level for input to the phase shifter 1030. In some example embodiments, a second attenuator may be used between the phase shifter 1030 and the amplifier 1024 to adjust the power of the signal to an appropriate level for amplification by the amplifier 1024. In some example embodiments, the attenuator(s) may be variable attenuators controlled by control electronics 1032. The control electronics 1032 may include one or more processors and memory for storing instructions. In an example embodiment, the phase shifter 1030 may be a voltage-controlled phase shifter controlled by the control electronics 1032.

In FIG. 10A, the control electronics 1032 is connected to the attenuator 1028, phase shifter 1030 and amplifier 1024. The control electronics 1032 provides signals to adjust the level of attenuation provided by the attenuator 1028, phase of phase shifter 1030, the class in which the amplifier 1024 operates (e.g., Class A/B, Class B or Class C mode) and/or the gain of the amplifier 1024 to control the power provided to the lamp body 1002. In one example embodiment, the amplifier 1024 has three stages, a pre-driver stage, a driver stage and an output stage, and the control electronics 1032 provides a separate signal to each stage (drain voltage for the pre-driver stage and gate bias voltage of the driver stage and the output stage). The drain voltage of the pre-driver stage can be adjusted to adjust the gain of the amplifier 1024. The gate bias of the driver stage can be used to turn on or turn off the amplifier. The gate bias of the output stage can be used to choose the operating mode of the amplifier 124 (e.g., Class A/B, Class B or Class C). The control electronics 1032 can range from a simple analog feedback circuit to a processor such as a microprocessor or microcontroller with embedded software or firmware that controls the operation of the lamp drive circuit 1006. The control electronics 1032 may include a lookup table or other memory that contains control parameters (e.g., amount of phase shift or amplifier gain) to be used when certain operating conditions are detected. In example embodiments, feedback information regarding an output intensity of the light from the lamp 1000 is provided either directly by an optical sensor 134, e.g., a silicon photodiode sensitive in the visible wavelengths, or indirectly by an RF power sensor 136, e.g., a rectifier. The RF power sensor 1036 may be used to determine forward power, reflected power or net power at the drive probe 1020 to determine the operating status of the lamp 1000. A directional coupler may be used to tap a small portion of the power and feed it to the RF power sensor 1036. The RF power sensor 1036 may also be coupled to the lamp drive circuit 1006 at the feedback probe 1022 to detect transmitted power for this purpose. In some embodiments, the control electronics 1032 may adjust the phase shifter 1030 on an ongoing basis to automatically maintain desired operating conditions.

While a variety of materials, shapes and frequencies may be used, one example embodiment includes a lamp body 1002 designed to operate in a fundamental TM resonant mode at a frequency of about 880 MHz (although the resonant frequency changes as lamp operating conditions change). In this example embodiment, the lamp has an alumina lamp body 1002 with a relative permittivity of 9.2. The lamp body 1002 may have a cylindrical outer surface as shown in FIG. 10B with a recess 1018 formed in the bottom surface. In an alternative embodiment shown in FIG. 10C, the lamp body 1002 is shown to have a generally rectangular outer surface. The outer diameter 1038 of the example lamp body 1002 shown in FIG. 10B may be about 40.75 mm and the diameter 1040 of the recess 1018 may be about 8 mm. The lamp body 1002 may have a height 1013 of about 17 mm. The narrow region 1012 forms a shelf over the recess 1018. The thickness 1011 of the narrow region 1012 may be about 2 mm. As shown in FIG. 10A, in the narrow region 112 of the lamp body 1002 the electrically conductive surfaces on the lamp body 1002 are only separated by the thin region 1012 of the shelf. Accordingly, a dielectric material (e.g., a glass frit coating) may be provided to reduce (ideally prevent) arcing between the electrically conductive surfaces. It should be noted that the above dimensions, shape, materials and operating parameters are examples only and other embodiments may use different dimensions, shape, materials and operating parameters.

Example Plasma Lamp with Horizontal Bulb

FIG. 11A shows a cross-sectional view of a plasma lamp 1100, according to an example embodiment, in which an elongate bulb 1104 of the lamp 1100 is orientated horizontally. The plasma lamp 1100 may have a lamp body 1102 formed from one or more solid dielectric materials, and the bulb 1104 is positioned horizontally adjacent to the lamp body 1102. The bulb 1104 contains a fill that is capable of forming a light emitting plasma, as herein before described with reference to FIGS. 10A-10C. A lamp drive circuit (e.g., a lamp drive circuit 1106 shown by way of example in FIG. 11C) couples radio frequency (RF) power into the lamp body 1102 which, in turn, is coupled into the fill in the bulb 1104 to form the light emitting plasma. In example embodiments, the lamp body 1102 forms a structure that contains and guides the radio frequency power (see FIGS. 10A-10C). The radio frequency power may be modulated using one or more of the methods described herein.

In the plasma lamp 1100, the bulb 1104 is positioned in a lamp opening 1110 provided in the lamp body 1102. The bulb 1104 is positioned and orientated so that a length of a plasma arc 1108 generally extends in a plane parallel to a front or upper side 1114 of the lamp body 1102 (as opposed to facing side walls 1112) to increase an amount of collectable light emitted from the plasma arc 1106 in a given etendue. Since the length of plasma arc 1108 is orientated in a direction of an applied electric field, the lamp body 1102 and the coupled RF power are configured to provide an electric field 1106 that is aligned or substantially parallel to a length of the bulb 1104 and the front or upper surface 1114 of the lamp body 1100. Thus, in an example embodiment, the length of the plasma arc 1108 may be substantially (if not completely) visible from outside the lamp body 1102. In example embodiments, collection optics may be in the line of sight of the full length of the bulb 1104 and plasma arc 1108. In other examples, about 40%-100%, or any range included therein, of the plasma arc 1108 may be visible to the collection optics in front of the lamp 1100. Accordingly, the amount of light emitted from the bulb 1104 and received by the collection optics may be enhanced. In example embodiments, a substantial amount of light may be emitted out of the lamp 1100 from the plasma arc 1108 through a front sidewall of the lamp 1100 without any internal reflection. As described herein, the lamp body 1102 is configured to realize the necessary resonator structure such that the light emission of the lamp 1100 is enabled while satisfying Maxwell's equations.

In an example embodiment, the lamp body 1102 is a solid dielectric body within a metal housing or enclosure. For example, metal housing or enclosure may be an electrically conductive coating 1116 which extends to the front or upper surface 1114. The lamp 1100 is also shown to include dipole arms 1118 and conductive elements 1120, 1122 (e.g., metallized cylindrical holes bored into the body 1102) to concentrate the electric field present in the lamp body 1102. The dipole arms 1118 may thus define an internal dipole. In an example embodiment, a resonant frequency applied to a lamp body 1102 without dipole arms 1118 and conductive elements 1120, 1122 would result in a high electric field at the center of the lamp body 1102. This effect would result from the intrinsic resonant frequency response of the lamp body 1102 due to its shape, dimensions and relative permittivity. However, in the example embodiment of FIG. 11A, the shape of the standing waveform inside the lamp body 1102 is substantially modified by the presence of the dipole arms 1118 and conductive elements 1120, 1122 and the electric field maxima is brought out to end portions 1124, 1126 of the bulb 1104 using the internal dipole structure. This results in the electric filed 1106 near the upper surface 1114 of the lamp 1102 being substantially parallel to the length of the elongate bulb 1104. In some example embodiments, this electric field 1106 is also substantially parallel to a drive probe and an optional feedback probe (see FIGS. 11C and 11D).

FIG. 11B shows a perspective exploded view of a composite lamp body, according to an example embodiment, with a bulb positioned horizontally relative to an outer upper surface of the lamp body. The composite lamp body of FIG. 11B provides an example embodiment of the lamp body 1102 shown in FIG. 11A and, accordingly, like references numerals indicate the same or similar features. The lamp 1100 is shown in an exploded view and includes the electrically conductive coating 1116 provided on an outer surface of the lamp body 1102 and selected internal surfaces to provide the conductive elements 1120, 1122. Surrounding interface material 1128 supports the elongate bulb 1104. Power may be fed into the lamp body 1102 with an electric monopole probe closely received within a drive probe passage 1130. The two opposing conductive elements 1120, 1122 may be formed electrically by the metallization of the bores 1132, 1134 which extend toward a center of the lamp body 1102 to concentrate the electric field, and build up a high voltage to energize the lamp 1100. The dipole arms 1118 connected to the conductive elements 1120, 1122 by conductive surfaces may transfer the voltage out towards the bulb 1104. The cup-shaped terminations or end portions on the dipole arms 1118 partially enclose opposed ends of the bulb 1104. A feedback probe passage 1136 is optionally provided in the lamp body 1102 to snugly receive an optional feedback probe that connects to a drive circuit (e.g. a lamp drive circuit shown by way of example in FIGS. 11C and 11D). In an example embodiment, the interface material 1128 may be selected so as to act as a specular reflector to reflect light emitted by the plasma arc 1108.

The lamp body 1102 is shown to be composite including outer body portions 1140, 1144 and inner body portion 1142. The body portions 1140 and 1144 are mirror images of each other and may each have a thickness of about 11.2 mm, a height 252 of about 25.4 mm, and a width 254 of about 25.4 mm. The inner portion 242 may have a thickness 255 of about 3 mm. The lamp opening 1110 in the upper surface 1114 may be partly circular cylindrical in shape having a diameter of about 7 mm and have bulbous end portions with a radius of about 3.5 mm. The drive probe passage 1130 and the feedback probe passage 1136 may have a diameter of about 1.32 mm. The bores 1132, 1134 of the conductive elements 1120, 1122 may have a diameter of about 7 mm. FIG. 11C shows an example of a drive circuit coupled to the lamp shown in FIG. 11A when a feedback probe is provided. As shown in FIG. 11C, the lamp drive circuit 106 may be used to drive the plasma lamp 1100.

FIG. 11C shows an example of a drive circuit 1150 coupled to the lamp 1100 shown in FIG. 11A when no feedback probe is provided. The lamp drive circuit 1150 is shown to include an oscillator 1152 and an amplifier 1154 (or other source of radio frequency (RF) power) may be used to provide RF power to a drive probe 1156. The drive probe 1156 is embedded in the solid dielectric body 1102 of the lamp 1100. Control electronics 1158 controls the frequency and power level provided to the drive probe 1156. The control electronics 1158 may include a processor (e.g., a microprocessor or microcontroller) and memory or other circuitry to control the lamp drive circuit 1150. The control electronics 1158 may cause power to be provided at a first frequency and power level for initial ignition, a second frequency and power level for startup after initial ignition and a third frequency and power level when the lamp 1100 reaches steady state operation. In some example embodiments, additional frequencies may be provided to match the changing conditions of the load during startup and heat up of the plasma. For example, in some embodiments, more than sixteen different frequencies may be stored in a lookup table and the lamp 1100 may cycle through the different frequencies at preset times to match the anticipated changes in the load conditions. In other embodiments, the frequency may be adjusted based on detected lamp operating conditions. The control electronics 1158 may include a lookup table or other memory that contains control parameters (e.g., frequency settings) to be used when certain operating conditions are detected. In example embodiments, feedback information regarding the lamp's light output intensity is provided either directly by an optical sensor 1034 (e.g., a silicon photodiode sensitive in the visible wavelengths), or indirectly by an RF power sensor 1160, e.g., a rectifier. The RF power sensor 1160 may be used to determine forward power, reflected power or net power at the drive probe 1156 to determine the operating status of the lamp 1100. A directional coupler 1162 may be used to tap a small portion of the power and feed it to the RF power sensor 1160. In some embodiments, the control electronics 1150 may adjust the frequency of the oscillator 1152 on an ongoing basis to automatically maintain desired operating conditions. For example, reflected power may be minimized in some embodiments and the control electronics may rapidly toggle the frequency to determine whether an increase or decrease in frequency will decrease reflected power. In other examples, a brightness level may be maintained and the control electronics may rapidly toggle the frequency to determine whether the frequency should be increased or decreased to adjust for changes in brightness detected by sensor 1034. It is to be noted that the above circuits, dimensions, shapes, materials and operating parameters are examples only and other embodiments may use different circuits, dimensions, shapes, materials and operating parameters.

In some example embodiments, a dielectric coating is applied over a portion of conductor elements where arcing may take place. For example, the dielectric coating may cover the surfaces 1114 of the lamp body 1102 in the opening 1110. The dielectric coating includes material properties that overcome technical hurdles such as arcing, and further satisfy other material needs for application within the plasma lamp 1100. In an example embodiment, a breakdown voltage of the dielectric coating is higher than a breakdown voltage of air. It is to be noted that the application of a non-conductive coating may be provided at any point and over any surface of the lamp 1100 (or lamp 1000) where there is a possibility of arcing. An example of a dielectric coating includes a glass coating such as silicon dioxide. Other glasses or mixtures of glasses are also within the scope of the example embodiments. The dielectric coating may be selected so as to be able to withstand temperatures in excess of 100 degrees Celsius. In an example embodiment, the dielectric coating may experience temperatures in excess of 350 degrees Celsius.

Example Plasma Lamp with Lumped Elements

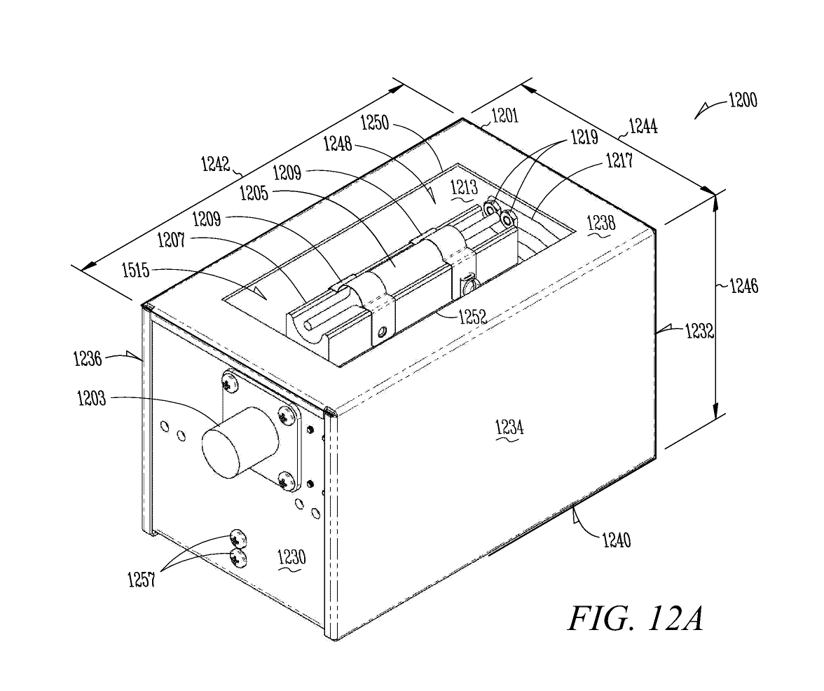

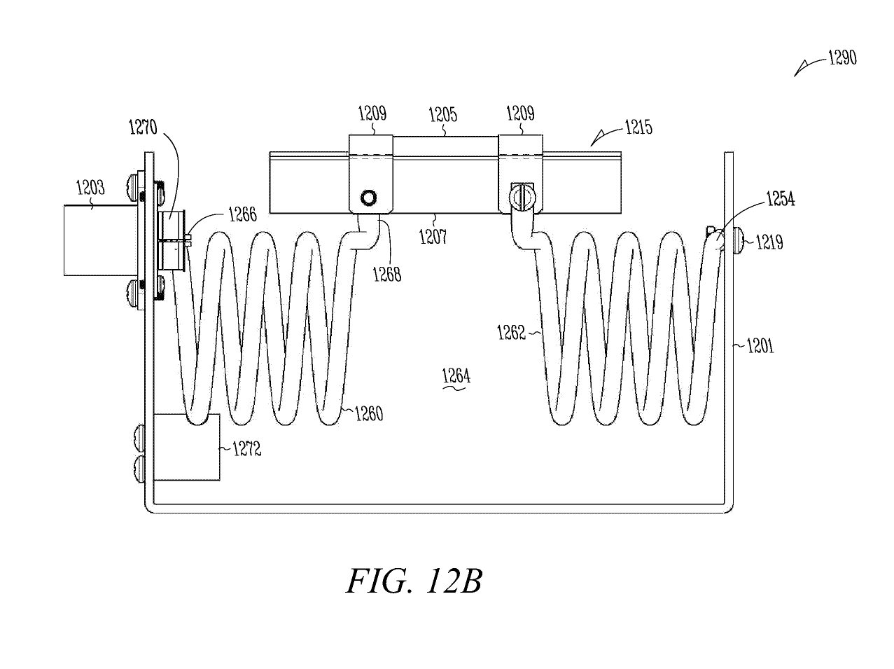

FIG. 12A shows electrodeless plasma lamp 1200, according to an example embodiment, including lumped components. The plasma lamp 1200 is operatively coupled to a power source and is shown, by way of example, to include a conductive enclosure 1201, an RF input port 1203, an elongate bulb 1205, a ceramic support 1207, and a pair of conductive straps 1209 to secure the bulb 1205 to the support 1207. The conductive straps 1209 may also form conductive applicators that apply power from the conductive enclosure 1201 to the bulb 1205. In an example embodiment, the conductive enclosure 1201 is a parallelepiped and has parallel end walls 1230 and 1232, parallel sidewalls 1234 and 1236, and parallel top and bottom walls 1238 and 1240. The plasma lamp 1200 is further shown to include a dielectric volume 1213 (e.g., air) within the conductive enclosure 1201, a bulb assembly 1215, a lumped inductive element in the example form of a ground coil 1217, and a pair of ground coil fasteners 1219. In an example embodiment, the plasma lamp 1200 may include components and design aspects of a single-ended balanced resonator. Likewise, the plasma lamp 1200 could include components and design aspects of a double-ended balanced resonator. Further, the radio frequency power may then be modulated using one or more of the methods described herein.

The dielectric cavity or volume 1213 may comprise a gas such as air or pressurized nitrogen, a liquid, a solid such as ceramic or ceramic powder, or some combination of these. The conductive enclosure 1201 is electrically conductive (e.g., either metallic or a metallization layer formed over a non-conductive material) and houses the various elements/components of the plasma lamp 1200. In the example plasma lamp 1200 (as well as in the plasma lamps 10, 1000 and 1100 for example) a resonant structure is formed by a metal enclosure forming at least part of a lamp body.

In an example embodiment, the conductive enclosure 1201 defines an air-filled resonator cavity and may also serve a variety of other functions. For example, the conductive enclosure 1201 may function as an EMI constraint or shield, thus limiting an amount of EMI emitted from the enclosure 1201. Additionally, the conductive enclosure 1201 may serve to conduct a ground return current from the ground coil 1217. The conductive enclosure 1201 can be fabricated from a number of different conductive materials such as aluminum, stainless steel, or any other suitable conductive material. Additionally, since the RF current skin depth is relatively shallow depending on frequency, the walls 1230, 1232, 1234, 1236, 1238, and 1240 of the conductive enclosure 1201 can be relatively thin. Accordingly, the conductive enclosure 1201 can be formed by a non-conductive material with a conductive coating or plating formed or otherwise deposited thereon. The conductive enclosure 1201 can be fabricated in a variety of ways such as, for example, a deep drawn box, a U-shaped sheet metal with appropriate channel bends for the end components, cast material (e.g., cast aluminum), or a variety of other forming techniques. Any seams may be soldered, braised, welded, adhered with conductive epoxy, or a variety of other attachment or sealing methods to limit EMI radiation emitted from the conductive enclosure 1201. The top wall 1238 may define an enclosure cover that can be, for example, formed or stamped and screwed, welded, or otherwise conductively adhered to the walls 1230, 1232, 1234 and 1236. In some example embodiments, the dielectric volume 1213 may be filled with solid, powdered, or fluid dielectrics.

In an example embodiment, the conductive enclosure 1201 may have a length 1242 of between 60 millimeters and 200 millimeters, a width 1244 of between 40 millimeters and 200 millimeters, and a height 1246 of between 40 millimeters and 200 millimeters. In some example embodiments, the length 1242 is 130 mm, the width 1244 is 80 mm and the height 1246 is 80 mm, defining a rectangular box with square end walls 1230, 1232. Although shown, by way of example, as rectangular in shape, other shapes include, for example, square, cylindrical, and spherical enclosures. The walls 1230, 1232, 1234, 1236, 1238, and 1240 of the conductive enclosure 1201 can be approximately 3 mm to 4 mm thick, although an exact thickness can be determined based on structural integrity required for a given application. The overall size of the conductive enclosure 1201 can be varied depending upon a number of factors including interior inductor design and bulb size.

The top wall 1238 has an opening 1248 (e.g., a rectangular opening) with longitudinal edges 1250, 1252 that are spaced a minimum distance from the pair of mounting members or conductive straps 1209 to prevent arcing over from the conductive straps 1209 to the top wall 1238. Arcing may also be prevented using other techniques. The conductive straps 1209 may have an applied voltage from RF coils, as discussed below by way of example, of approximately 2000 volts (as measured strap-to-strap). In an example, the distance may be between 2 millimeters and 20 millimeters for an applied voltage of between 100 volts and 10 kilovolts. The opening 1248 may be sized to enhance the amount of light exiting the plasma lamp 1200.

In an example embodiment, the ceramic support 1207 defines an example seat in or on which the bulb 1205 is received. In an example embodiment, the ceramic support 1207 may have insulating formations that wrap over or cover the conductive straps 1209 to reduce the possibility of arcing.

The bulb assembly 1215 may comprise the bulb 1205, the ceramic carrier 1207, and the pair of conductive straps 1209. The bulb 1205 may be similar to the bulbs 1004 and 1104 shown in FIGS. 10A and 11B-11D. The ceramic support 1207 may also serve as a heat sink or a diffuse scattering reflector to reflect light from the bulb 1205 out of the plasma lamp 1200. The ceramic support 1207 may be formed from various materials that are at least partially thermally conductive and capable of reflecting at least visible light. One such material that can be used to form the ceramic support 1207 is alumina (Al₂O₃).

FIG. 12B shows a cross-sectional view of the lamp 1200 of FIG. 12A showing example detail of an interior of the enclosure 1201. The plasma lamp 1200 is shown to include lumped elements in the form of coils 1260 and 1262. The coil 1260 functions as an RF input coil is disposed within an air-cavity 1264 formed by the conductive enclosure 1201 and may function as a partial quarter-wave phase shifter. The coil 1260 may comprise of a length of conductive wire formed into a coil. In an example embodiment, the coil 1260 has an air core. This lumped element allows electric or magnetic energy to be concentrated in it at specified frequencies, and inductance or capacitance may therefore be regarded as concentrated in it, rather than distributed over the length of the line.

Due to capacitive coupling effects between an input-matching network and a first end 1266 of the coil 1260, and between the conductive straps 1209 and its second end 1268, the actual length of the coil 1260 may be somewhat shorter than λ/4. Dimensions of the coil 1260 are typically derived from an estimate of the required inductance. The necessary inductance to produce resonance at a particular frequency may be calculated based on estimated values for the plasma resistance, and also the coupling capacitance between the field applicators (e.g., the conductive straps 1209) and the plasma formed in the bulb 1205. Once an inductance value is calculated, the coil dimensions may be calculated simply from a number of widely available empirical formulas. An example of such a formula for air-core cylindrical coils is L=r²n²/(9r+10l), where L is the inductance in microhenries, r is the coil outer radius in inches, n is the number of turns, and l is the total coil length. In one example embodiment, operating at 80 MHz, the relevant parameters are r=22 millimeters (0.866 inches), l=40 millimeters (1.575 inches), and n=4, for a total inductance of 0.51 microhenries (510 nanohenries). In this example embodiment, identical coils are used for both the coil 1260 and 1262. The coil 1262 may form the grounded coil 1217. It will be appreciated that, in other example embodiments, the two coils 1260, 1262 have different inductance values. In some example embodiments, the inductors may be realized by different geometries, for example a straight wire for the input inductor, and a coil for the ground inductor. In example embodiments, coil inductances may range from 5 nanohenries to 5000 nanohenries (5 microhenries) or any value between, depending on the desired operating frequency. The coil radius may range from 2 millimeters to 60 millimeters. The overall coil length may range from 10 millimeters to 200 millimeters, again depending on the required inductance. The number of turns can be high to maximize inductance without, for example, requiring a large coil radius. The above formula for inductance does not include self-resonant effects of coil geometry. For a very tightly wound coil (very high ‘n’), the capacitance between adjacent turns can be significantly large that it creates a self-resonance within the coil at or below the intended operating frequency of the lamp. In example embodiments, this condition is to be avoided, and self-resonance in coils typically needs to be identified empirically by building and measuring characteristics of various coil designs, including the loading effects of the conductive shielding around the coil. The coil 1260 may be coupled to the RF input port 1203 via an impedance matching network 1270. Optionally, an RF input coil support 1272 is provided. The RF input coil support 1272 provides structural support for the coil 1260 and can be formed from any non-conductive material such as Teflon® or other fluoropolymer resins, Delrin®, or a variety of other materials known independently in the art. Although not shown, the coil 1262 could also be supported in any suitable manner.

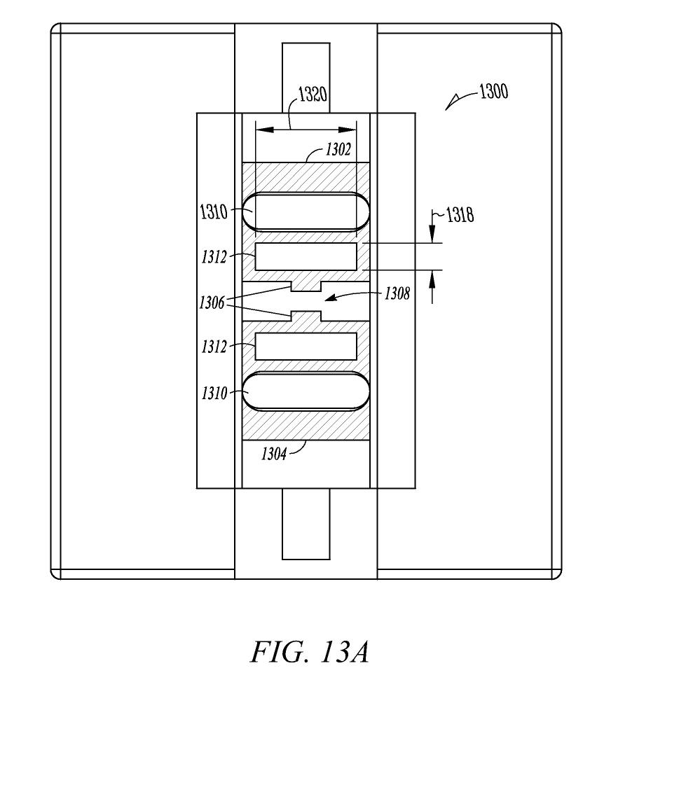

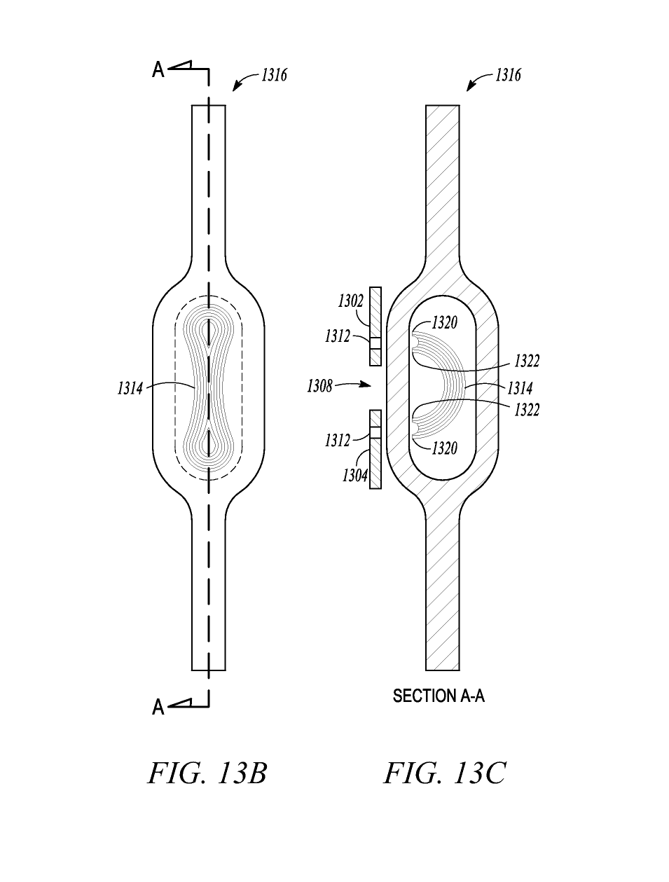

FIG. 13A shows a plasma arc shaping arrangement 1300, according to an example embodiment, to modify a position and shape of a plasma arc. The arc shaping arrangement 1300 may be used in the example plasma lamps 1000, 1100 and 1200.

The arc shaping arrangement 1300 is shown to include shaping elements 1302 and 1304. In an example embodiment, the shaping elements 1302 define opposing metal protrusions 1306 that extend into a gap 1308 between the shaping elements 1302 and 1304. In various example embodiments, there may be more than one pair of opposing metal protrusions 1306 to shape the plasma arc in different ways. The opposing metal protrusions 1306 may provide a localized enhancement of the dipole electric field to improve the lamp ignition characteristics. Once RF power is applied to the arc shaping arrangement 1300, the electric field will be strongest between the opposing protrusions 1306, since the gap distance there is shortest.

In an example embodiment, the opposing protrusions 1306 have little effect on a plasma arc. The protrusions 1306 may be used primarily to assist ignition of one or more plasma arcs. As long as the protrusions 1306 are relatively small in comparison to an overall size of the shaping elements 1302, 1304, which may form a dipole antenna, they may not significantly impact dipole impingement. In an example embodiment, the size of the protrusions for aiding ignition is not be critical. The electric field enhancement produced by the protrusions 1306 is inversely proportional to the distance of the narrow gap 1308 between the protrusions 1306. For example, as a distance of the narrow gap 1308 is decreased by a factor of two, the electric field enhancement is approximately doubled. A width of the fingers may also have an effect on how much boost is provided to the electric field, but may not be as influential as the distance of the narrow gap.

In an example embodiment, RF power is conducted through the pair of oval slots 1310 that may be formed in a dielectric body (e.g., the lamp body 1102 shown in FIG. 11A). The pair of oval slots 1310 may be internally coated or filled with an electrically conductive material to conduct the RF power to the shaping elements 1302 and 1304 that form a dipole antenna.

The shaping elements 1302, 1304 include optional rectangular of slots 1312 that define nonconductive areas. Accordingly, the slots 1312 are not metalized and, therefore, do not conduct RF power, and effectively create “dead-zones” for the generated electric field. The slots 1312 therefore de-localize and spread plasma impingement points on either side of the slots 1312 (see FIG. 13C). Consequently, the plasma impingement points of a plasma arc 1314 are spread over larger areas of a bulb 1316. The slots 1312 can be formed by either removing the conductive material within the areas defined by the slots 1312 or, alternatively, the area of the slots can be masked prior to applying the conductive material. For example, a polymeric or lithographic mask having the desired dipole metal pattern may be applied. The conductive coating (e.g., silver) may then be brushed or otherwise coated onto substantially only those areas of the lamp body exposed by the mask. In other example embodiments, the shaping elements 1302, 1304 may be metal plates located proximate to a bulb (e.g., the bulbs 1004, 1104, 1305, and 1316) and shaped and dimensioned to modify the plasma arc within the bulb.

In an example embodiment, the slots 1312 may have a dimensional width that is limited by the physical distance between the pair of opposing protrusions 1306 and a width of pair of oval slots 1310. In an example embodiment, a minimum width 1318 of the slots 1312 is dependent on a distance from the metalized areas to the bulb (e.g., the bulbs 1004, 1104, 1305, and 1316) and a thickness of the walls of the bulb (e.g., the bulbs 1004, 1104, 1305, and 1316). As the distance to the bulb and the thickness of the wall increases, the slot width may need to increase to ensure an effective “dead-zone” for the generated electric field. In an example embodiment, the slot width 1318 is approximately 1 mm. Based on this example dimension, additional pairs of slots may be added to the shaping elements 13102, 1304 to create additional dead-zones provided there is enough space, physically (based at least partially on the size of the lamp body and the size of the bulb), to place additional slots. Generally, each of the additional slots may be approximately 1 mm away from any adjacent slot. A length 1320 of each slot may be up to 80% or more of the overall width of the metalized areas provided by the shaping elements 1302 such that at least a portion of electrically conductive material remains on either side of the slots 1312 to conduct current from the oval slots 1310 to the opposing protrusions 1306.

FIG. 13B shows plan view of an example plasma arc 1314 formed by the plasma arc of a bulb shaping arrangement 1300 of FIG. 13A. The plasma arc may be formed, for example, in the bulbs 1004, 1104, 1305, and 1316 when placed in proximity to the slotted design dipole metal pattern formed by the shaping elements 1302, 1304. It will be noted that each end of the plasma arc 1314 has two impingement points 1320, 1322. Different configurations of the shaping elements 1302, 1304 may create additional impingement points. The shaping elements 1302, 1304 may thus increase the area of where the plasma arc 1314 attaches to a wall of the bulb. As the plasma is attached to the bulb wall in a more distributed manner, the peak power density of heat conducted from the plasma to the bulb (e.g., a quartz bulb) is reduced. Accordingly, there is less chance the ends of the plasma arc can cause melting of the bulb wall. Thus, the slotted design may spread the plasma arc impingement points 1320, 1322 over a larger area on the bulb.

In an example embodiment, the slotted dipole design is used in electrodeless plasma lamps mounted facing downward. Example deployments in this mounting configuration include street lighting, parking lot lighting, and other outdoor applications.

What is claimed:

1. An electrodeless plasma lamp comprising:
a metal enclosure having a conductive boundary forming a resonant structure;
a radio frequency (RF) feed to couple RF power from an RF power source into the resonant cavity;
a bulb containing a fill that forms a light emitting plasma when the power is coupled to the fill, the bulb being received at least partially within an opening in the metal enclosure; and
a controller to modulate the RF power to induce acoustic resonance in the plasma.

2. The plasma lamp of claim 1, wherein the controller modulates the power to excite at least one acoustic resonance mode in a plasma arc formed by the plasma.

3. The plasma lamp of claim 2, wherein the acoustic resonance modifies a position of the plasma arc, the plasma arc being position closer to an exposed bulb wall when the RF power is modulated than when the RF is not modulated.

4. The plasma lamp of claim 2, wherein the acoustic resonance modifies a temperature profile of the plasma arc.

5. The plasma lamp of claim 1, wherein the fill includes metallic mercury in combination with one or more metal halide salts selected from the group consisting of TmX₃, HoX₃, DyX₃, CeX₃, and InX₃, where the X=chlorine, bromine or iodine.

6. The plasma lamp of claim 1, wherein the fill includes an inert starting gas selected from the group consisting of Ar, Kr and Xe.

7. The plasma lamp of claim 1, wherein the controller modulates the power to excite acoustic resonance at a first radial acoustic mode.

8. The plasma lamp of claim 1, wherein the controller modulates the RF power at a modulation frequency, the controller being further configured to sweep a modulation frequency to operate the plasma lamp partially in a stable range of frequencies and partially in an unstable range of frequencies.

9. The plasma lamp of claim 8, wherein an envelope of the RF power is modulated at a frequency of between 100 Hz and 200 000 Hz, the stable range of frequencies being between 80 kHz and 100 kHz, and the unstable range of frequencies being between 60 kHz and 90 kHz on the low side and 90 kHz and 120 kHz on the high side.

10. The plasma lamp of claim 1, wherein the controller is configured to sweep a modulation frequency between a low modulation frequency and high modulation frequency.

11. The plasma lamp of claim 10, wherein the low modulation frequency is about 50 KHz and the high modulation frequency is about 120 KHz.

12. The plasma lamp of claim 11, wherein the low modulation frequency is about 84 KHz and the high modulation frequency is about 92 KHz.

13. The plasma lamp of claim 10, wherein the modulation frequency is an acoustic resonant frequency for the bulb.

14. The plasma lamp of claim 1, wherein the modulation is pulse width modulation.

15. The plasma lamp of claim 14, wherein the pulse width modulation has a duty factor of between about 0.5 and 1.

16. The plasma lamp of claim 15, wherein the pulse width modulation has a duty factor of between about 0.8 and 0.9.

17. The plasma lamp of claim 14, wherein the controller is configured to sweep a duty cycle of the pulse width modulation.

18. The plasma lamp of claim 1, wherein the modulation is sawtooth modulation.

19. The plasma lamp of claim 1, wherein a frequency of modulation of the RF power is less that a carrier frequency of the RF power.

20. The plasma lamp of claim 1, wherein a difference between a frequency of the RF power is more than one octave from a frequency of the acoustic modulation.

21. The plasma lamp of claim 1, wherein the controller is configured to determine a lamp volatility resulting from modulation of the RF power, the volatility indicating a magnitude of flicker of a plasma arc.

22. The plasma lamp of claim 21, wherein the controller adjusts the modulation frequency based on the determined volatility.

23. A method of powering a plasma lamp, the method comprising:
generating RF power at resonant frequency for a resonant structure, wherein the RF power is modulated at a modulation frequency;
coupling the power into the resonant structure, the resonant structure including a metal enclosure having a conductive boundary;
coupling the power from the resonant structure to a bulb containing a fill that forms a light emitting plasma when the power is coupled to the fill, the bulb being received at least partially within an opening in the metal enclosure; and
causing acoustic resonance in the plasma induced by the modulation.

24. A method of claim 23, further comprising sweeping the modulation frequency between a low modulation frequency and high modulation frequency.

25. A method of claim 24, wherein the low modulation frequency is about 50 KHz and the high modulation frequency is about 120 KHz.
